(19) United States
(12) Patent Application Publication
(10) Pub. No.: US 2024/0370805 A1
(43) Pub. Date: Nov. 7, 2024

(54) METHODS FOR GRAPHICALLY DISPLAYING AVIATION EMISSIONS INFORMATION

(71) Applicant: The Boeing Company, Arlington, VA (US)

(72) Inventors: Jonas Schulze, Frankfurt (DE); Hilna Sahle, Darmstadt (DE); Anna-Lisa Mautes, Darmstadt (DE); Daniel Artic, Biebesheim (DE); Michael Gottscheck, Frankfurt (DE); Rahul Ashok, Singapore (SG); Neil Titchener, Jackson, NH (US); Nicholas Applegate, Long Beach, CA (US); Hubert Wong, Huntington Beach, CA (US); Nadine Akari, Lynnwood, WA (US); Lisa Liu, Paramus, NJ (US); David Raymond, Reston, VA (US); Brian Yutko, Somerville, MA (US); Addison Salzman, Boston, MA (US); James Abel, Seattle, WA (US); Abhinav Mahesh, London (GB)

(21) Appl. No.: 18/778,693

(22) Filed: Jul. 19, 2024

Related U.S. Application Data
(63) Continuation-in-part of application No. 18/352,947, filed on Jul. 14, 2023.
(60) Provisional application No. 63/501,945, filed on May 12, 2023.
(60) Provisional application No. 63/382,001, filed on Nov. 2, 2022.
(60) Provisional application No. 63/368,774, filed on Jul. 18, 2022.

(51) Int. Cl. G06Q 10/0637; G06T 11/20

(52) U.S. Cl. CPC G06Q 10/06375; G06T 11/206; G06T 2200/24

(57) ABSTRACT

A method is presented for graphically displaying aviation emissions information. The method comprises receiving a global database comprising flight parameters for a plurality of flights over a time period, the flight parameters including at least aviation emissions information for each of the plurality of flights. Aspects of the aviation emissions information are graphically displayed on a display device based on a default model. One or more modeling strategies for reducing aviation emissions over time are presented on the display device via a graphic user interface (GUI). User input indicating input values for one or more strategic parameters of the one or more modeling strategies is received via the GUI. The strategic parameters are applied to the global database to generate modeled emissions information. The graphical display of aspects of the aviation emissions information is adjusted based on the modeled emissions information.

### CROSS REFERENCE TO RELATED APPLICATIONS

This application is a continuation-in-part to U.S. patent application Ser. No. 18/352,947, entitled “SYSTEM AND METHOD FOR DYNAMIC DISPLAY OF AIRCRAFT EMISSIONS DATA,” filed Jul. 14, 2023, which in turn claims priority to U.S. Provisional Patent Applications, 63/501,945, 63/382,001 and 63/368,774, filed May 12, 2023, Nov. 2, 2022 and Jul. 18, 2022, all entitled “SYSTEM AND METHOD FOR DYNAMIC DISPLAY OF AIRCRAFT EMISSIONS DATA,” the entireties of which are hereby incorporated by reference for all purposes.

### FIELD

The present disclosure generally relates to presentment of emissions data for one or more aircraft.

### BACKGROUND

The aviation industry has pledged to maintain 2019 levels of carbon emissions out to 2050 and to also reach net-zero carbon emissions by the end of that timeframe. There are many different ways to apply sustainability measures or strategies. However, existing techniques for displaying emissions data for the aviation industry include static views, graphs, and/or charts of discrete aspects of the available data, thus making it difficult and time-consuming to model and/or analyze such data and determine which of the strategies to implement.

### SUMMARY

A method is presented for graphically displaying aviation emissions information. The method comprises receiving a global database comprising flight parameters for a plurality of flights over a time period, the flight parameters including at least aviation emissions information for each of the plurality of flights. Aspects of the aviation emissions information are graphically displayed on a display device based on a default model. One or more modeling strategies for reducing aviation emissions over time are presented on the display device via a graphic user interface (GUI). User input indicating input values for one or more strategic parameters of the one or more modeling strategies is received via the GUI. The strategic parameters are applied to the global database to generate modeled emissions information. The graphical display of aspects of the aviation emissions information is adjusted based on the modeled emissions information.

This Summary is provided in order to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any disadvantages noted in any part of this disclosure.

### BRIEF DESCRIPTION OF THE DRAWINGS

The patent application file contains at least one drawing executed in color. Copies of this patent or patent application publication with color drawing(s) will be provided by the Office upon request and payment of the necessary fee.

FIG. 1 is a screenshot of an exemplary graphical user interface for depicting an exemplary map view of a dynamic aviation emissions modeling tool, the map view including all flight paths in a given year and corresponding emissions data, in accordance with certain embodiments.

FIGS. 2A to 3B are close-up screenshot views of a timeline variable and the emissions data portion of the map view of FIG. 1 as the timeline variable is changed from year to day, in accordance with certain embodiments.

FIG. 4 is another screenshot of an exemplary graphical user interface for depicting a chart view showing the CO2 emissions impact of a second set of sustainability strategies, in accordance with certain embodiments.

FIG. 5 is a screenshot of an exemplary graphical user interface for depicting a dynamic view of the dynamic aviation emissions modeling tool, the dynamic view including emissions data over a select period of time for a filtered set of flight paths, in accordance with certain embodiments.

FIG. 6A is a screenshot of another exemplary graphical user interface for depicting another dynamic view of the dynamic aviation emissions modeling tool, the dynamic view including a carbon emissions chart showing emissions data over a select period of time and for a select group of flight paths, in accordance with certain embodiments.

FIG. 6B is a close-up view of a plurality of levers shown in the dynamic view of FIG. 6A, in accordance with certain embodiments.

FIG. 7A is another screenshot of an exemplary dynamic view depicting an expanded state of the Market Based Measures lever only, in accordance with certain embodiments.

FIG. 7B is close-up view of the expanded Market Based Measures lever shown in FIG. 7A, in accordance with certain embodiments.

FIG. 8 is a screenshot of an exemplary graphical user interface for depicting a forecast scenarios view of a dynamic aviation emissions modeling tool, in accordance with certain embodiments.

FIG. 9 is a screenshot of an exemplary outlook view included in the forecast scenarios view of FIG. 8, the outlook view graphically depicting user selection of various market-based measures options, in accordance with certain embodiments.

FIG. 10 is a screenshot of an exemplary annual view included in the forecast scenarios view of FIG. 8, the exemplary annual view corresponding to the outlook view shown in FIG. 9, in accordance with certain embodiments.

FIGS. 11A and 11B are screenshots of additional exemplary annual views included in the forecast scenarios view of FIG. 8, the additional views showing pop-up screens with measurement values corresponding to percentage values displayed on the screen, in accordance with certain embodiments.

FIGS. 12A to 12C are screenshots of exemplary outlook, annual, and map views, respectively, included in the forecast scenarios view of FIG. 8, the annual and map views corresponding to a second user-selected year and the outlook view graphically depicting user selection of the second year, in accordance with certain embodiments.

FIG. 13 is a screenshot of another exemplary graphical user interface for depicting another dynamic view of the dynamic aviation emissions modeling tool, the dynamic view including a net CO2 emissions chart showing emissions data over a select period of time and for a select group of strategic parameters, in accordance with certain embodiments.

FIG. 14 is a close-up view of a plurality of strategic parameters shown in the dynamic view of FIG. 6A, in accordance with certain embodiments.

FIG. 15 is a screenshot of an exemplary dynamic view depicting an expanded state of the aircraft type evolution strategic parameters only, in accordance with certain embodiments.

FIG. 16 is screenshot of an exemplary hart view showing the CO2 emissions impact of a set of aircraft type evolution strategic parameters, in accordance with certain embodiments.

FIG. 17 is a close-up view of a plurality of levers shown in the dynamic view of FIG. 15, in accordance with certain embodiments.

FIG. 18 is a screenshot of an exemplary dynamic view depicting an expanded state of the aircraft energy sources strategic parameters only, in accordance with certain embodiments.

FIG. 19A is a close-up view of a plurality of levers shown in the dynamic view of FIG. 18, in accordance with certain embodiments.

FIG. 19B is a close-up view of a plurality of levers shown in the dynamic view of FIG. 18, in accordance with certain embodiments.

FIG. 20 schematically shows a computing system for graphically displaying aviation emissions information.

FIGS. 21A and 21B show a flow diagram for an example method of graphically displaying aviation emissions information.

FIG. 22 schematically shows aspects of an example computing system.

### DETAILED DESCRIPTION

The description that follows describes, illustrates, and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a clearer description. In addition, system components can be variously arranged, as known in the art. Also, the drawings set forth herein are not necessarily drawn to scale, and in some instances, proportions may be exaggerated to more clearly depict certain features and/or related elements may be omitted to emphasize and clearly illustrate the novel features described herein. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

Existing tools for displaying emissions data for the aviation industry lack detailed analysis and dynamic depiction of the dependencies between different strategies to reduce emissions (e.g., CO2 emissions). Systems and methods described herein provide a dynamic display tool (or graphical user interface) configured to visualize various sustainability strategies in an easily discernible and interactive manner that can help improve the user's understanding of the dependencies between the strategies. In embodiments, the dynamic display tool (also referred to herein as a “dynamic aviation emissions modeling tool”) includes various graphical elements, including, e.g., interactive levers, sliders, or other input devices, for representing the different sustainability strategies and for allowing selection and/or adjustment of each strategy. The dynamic display tool also includes various graphics or graphical elements for visually and dynamically depicting the environmental impact of implementing the selected strategies and the dependencies between them. For example, the dynamic tool may be used to display the impact of using hydrogen aircraft on emissions and hydrogen carbon intensity. The techniques described herein may be useful to various entities including, for example, regulators, airlines, research institutes, and other users interested in different sustainability strategies for the aviation industry and how they can mitigate CO2 emissions, interact with each other, and/or are dependent on each other.

According to embodiments, exemplary sustainability strategies or options may include: (1) fleet renewal, or changing a composition of the aircraft in the fleet (e.g., from the current A/C type to the latest A/C type), (2) future aircraft, or changing the aircraft technology used (e.g., from conventional aircraft to hydrogen aircraft, electric aircraft, or other next generation aircraft), (3) operational efficiency improvement, or assessing the total improvement in efficiency, (4) sustainable aviation fuel (“SAF”), or increasing the use of renewable energy sources (e.g., for electric aircraft, changing the electricity grid composition from fossil fuel sources to renewable energy sources; for hydrogen aircraft, changing the hydrogen carbon intensity from black to grey, blue, or green; etc.), and looking at the global SAF market share being utilized by the aviation industry, and (5) market-based measures. As will be appreciated, other sustainability strategies may be used in addition to, or instead of, the above-listed strategies, in accordance with the techniques described herein.

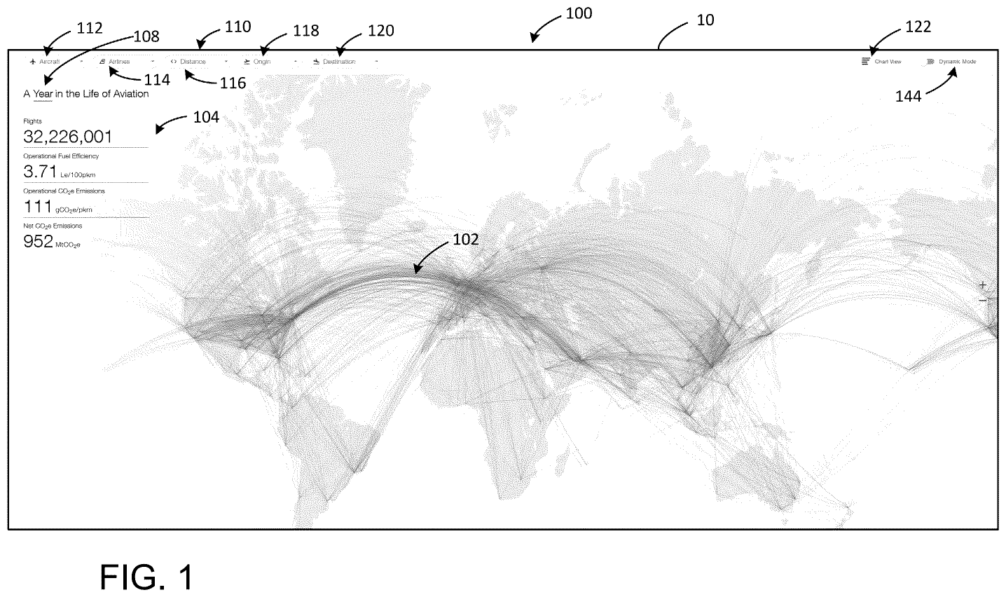

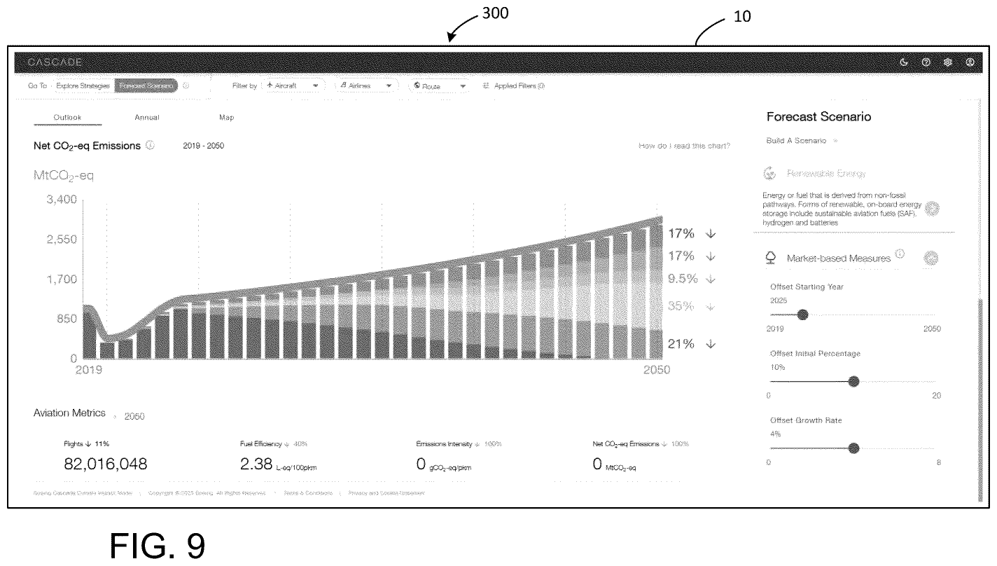

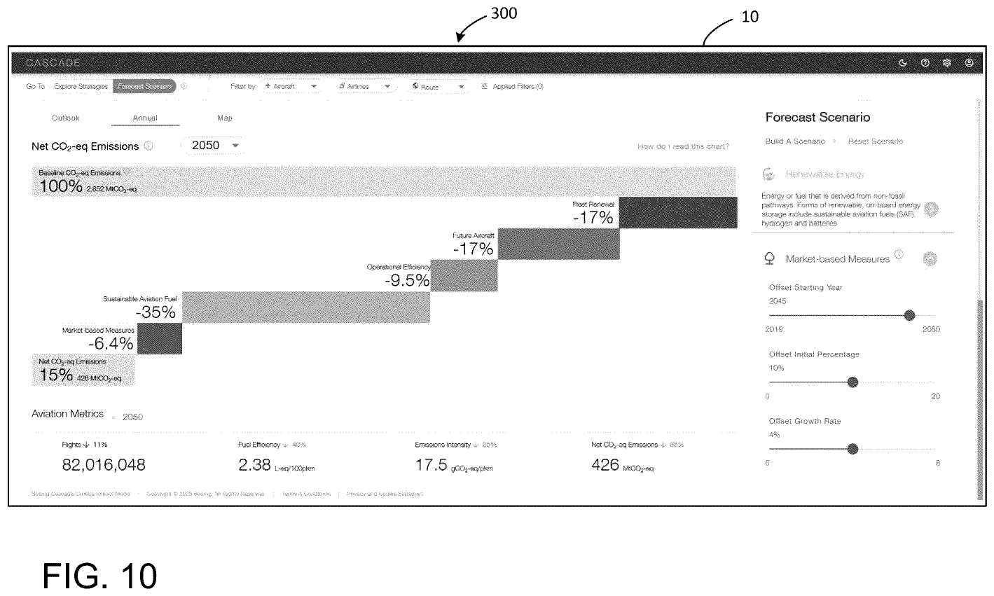

In the following paragraphs, these and other aspects of the dynamic display tool will be described in more detail with reference to FIGS. 1 through 20, which show exemplary aviation strategies graphical user interfaces (“GUIs”) for implementing various aspects of the dynamic display tool on an electronic device. Some of the graphical user interfaces shown in FIGS. 1 through 20 may be substantially similar in overall design and operation but may differ in terms of content, due to a difference in the inputs received from the user for selecting certain sustainability strategies, flights, and/or other parameters. It should be appreciated that the graphical user interfaces shown herein are merely exemplary and can comprise various other details, arrangements, and/or selectable options.

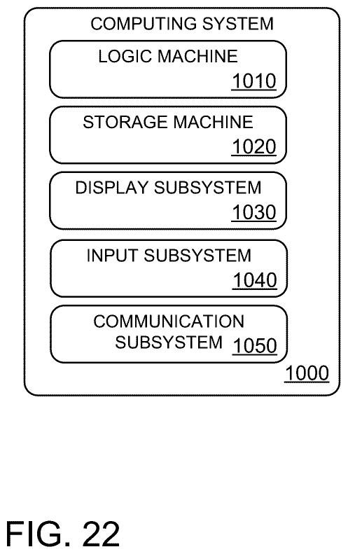

In embodiments, one or more of the GUIs may be generated or provided by a system or computing device (e.g., computing device 1000 in FIG. 22) and displayed on a display screen or other display device for presentation to the user, such as, e.g., display screen 10 shown in the figures. While the illustrated embodiments depict a GUI with a particular shape and size configured for presentation on, for example, a personal computer, laptop, or stand-alone display screen, it is contemplated that the techniques described herein can also be used to provide GUIs having other formats or configurations to accommodate other types of electronic devices and/or display screen sizes, such as, for example, tablets, smartphones, televisions, and other media devices.

All or portions of the dynamic display tool may reside on a remote computing device (e.g., server) that is in communication (e.g., via wired and/or wireless networks) with a client device of a user configured to display the GUI 100 on a display screen of the client device. User inputs received via the dynamic display tool (e.g., strategy selections) may cause or trigger a call to backend services, such as the remote server, a remote database coupled thereto, or other backend device, in order to request a data set that is tailored to the user's preferences (e.g., strategy selections).

In embodiments, the dynamic display tool may be configured, for example, using software executed by a computing device, to receive, from the backend services, aviation emissions information for a plurality of flights and a select period of time, and graphically present, via the aviation strategies graphical user interface, the aviation emissions information in association with a plurality of adjustable sustainability strategies. The dynamic display tool may be further configured to dynamically adjust the graphical presentation of one or more aspects of the aviation emissions information based on a user input for adjusting a selected strategy, as described herein. The aviation emissions information may include carbon emissions information, other emissions information, and/or any other data useful for studying and evaluating the environmental impact of the aviation industry. The aviation emissions information may include measured data collected for a past portion of the select time period (e.g., from 2019 until present day) and forecasted data determined based on projections for a future portion of the select time period (e.g., the next ten years). The forecasted data may be determined based on the measured data, expected changes over time (e.g., population growth, technological advances, etc.), predicted impacts of each sustainability strategy, and/or other relevant data.

FIG. 1 illustrates an aviation strategies graphical user interface (or GUI) 100 configured to graphically display a plurality of flights 102 in a geographic map view, or on a map of the world (also referred to herein as a “geographic map user interface”). In the illustrated embodiment, each flight 102 (or flight path) is represented by a thin line that extends between the starting point and the destination. Other depictions of the flight paths 102 are also contemplated. Also, while the illustrated map shows the whole world, it should be appreciated that the map view may be limited to smaller sections of the world in other embodiments.

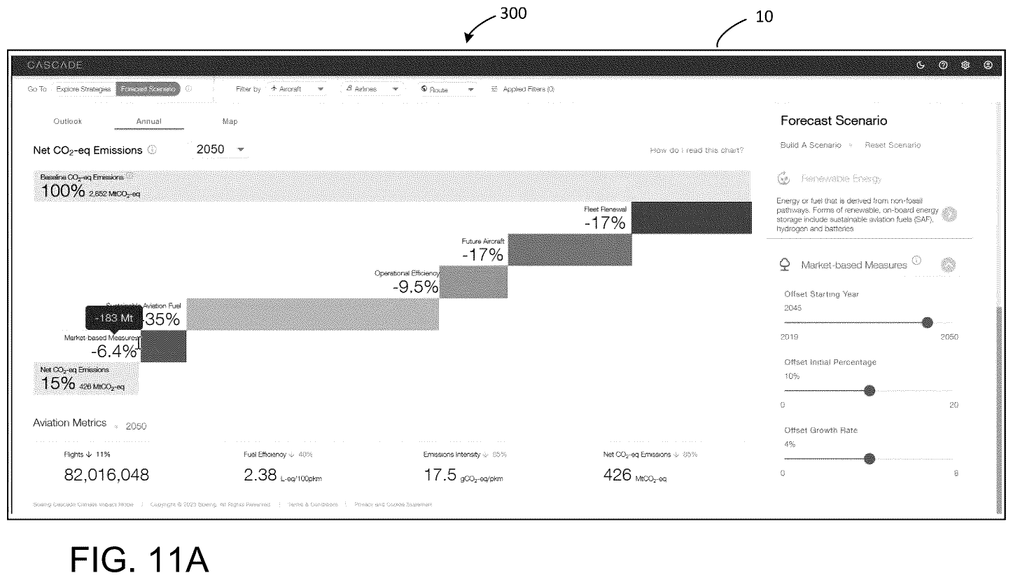

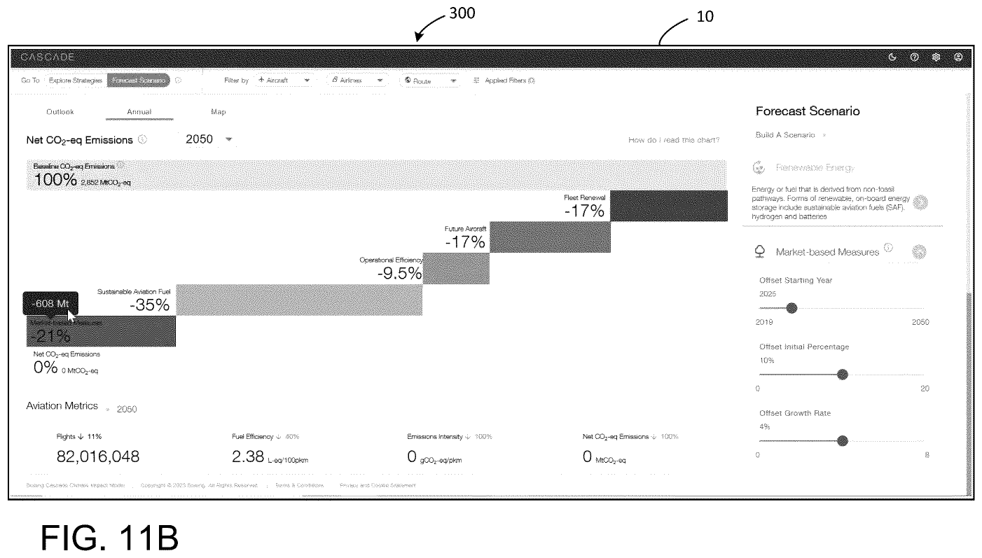

The GUI 100 is also configured to display a table or chart 104 for listing select metrics related to the emissions impact of the depicted flights 102. For example, the table 104 lists data, or metrics, for the total number of flights shown on the map, the operational fuel efficiency of those flights (e.g., in Le/100 pkm, or petrol liters equivalent per passenger per 100 kilometers (km)), the operational CO2 emissions level for those flights (e.g., in gCO₂e/pkm, or grams of CO₂ equivalent per passenger per 100 km), and net CO2 emissions (e.g., in MtCO₂e). In other embodiments, the GUI 100 may be configured to display additional and/or different metrics in the table 104. In some cases, the GUI 100 may be configured to allow user selection of the units used for the displayed metrics. In general, the table 104 is configured to provide the metrics in a clear and easily discernible manner. For example, the metrics are displayed as text with a title line and a value line below it, where the value line contains the value and the unit. The GUI 100 may also be configured to display a tooltip or explanation of each metric when the user hovers over the unit depiction, for example, as shown in FIGS. 11A and 11B. In other embodiments, the GUI 100 may be configured to display the metrics in other, easily discernible formats (i.e. pie chart, block diagram, etc.).

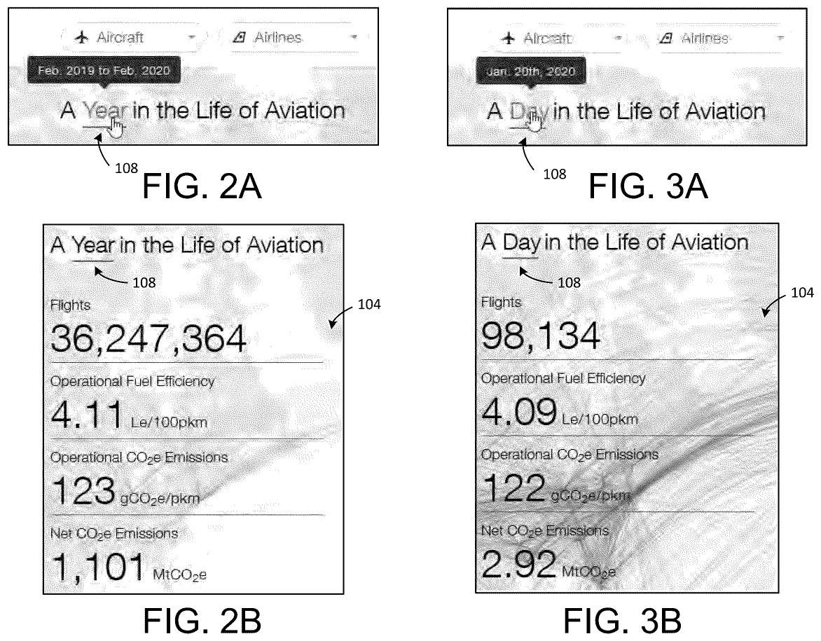

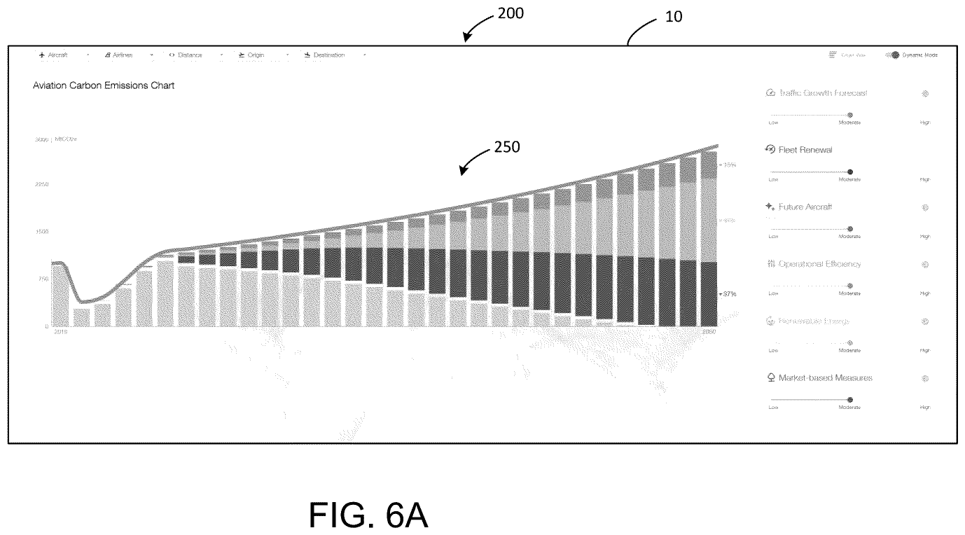

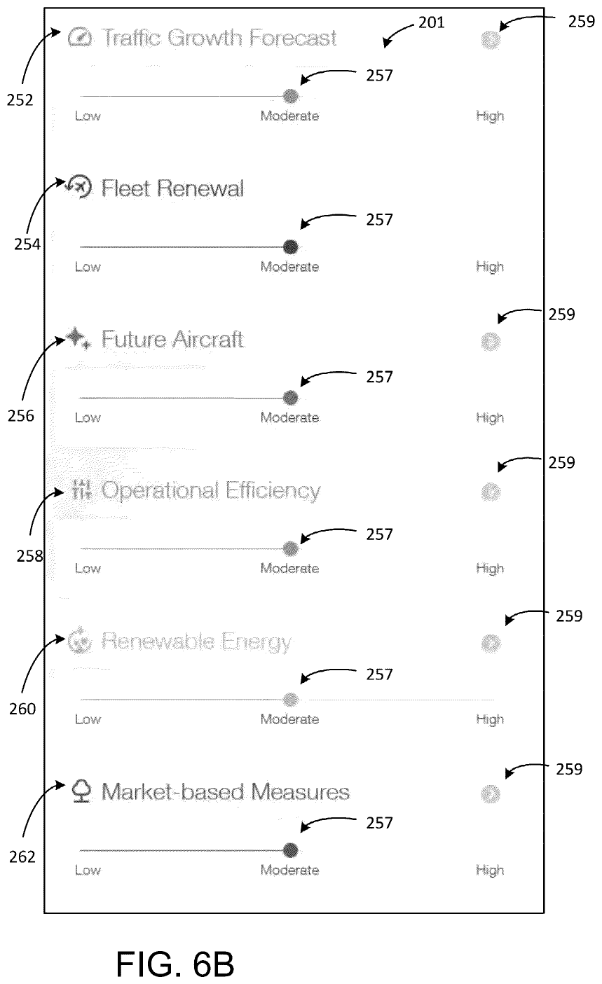

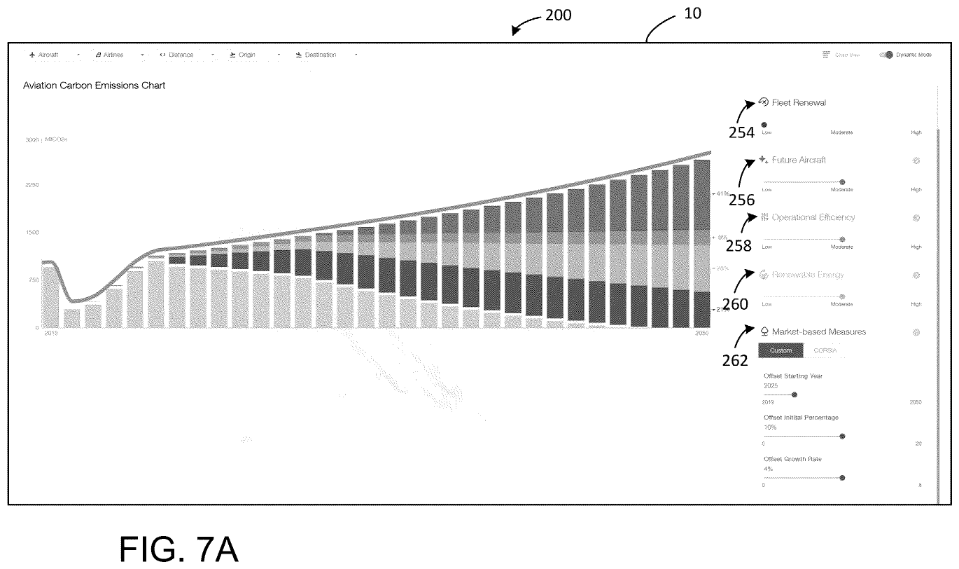

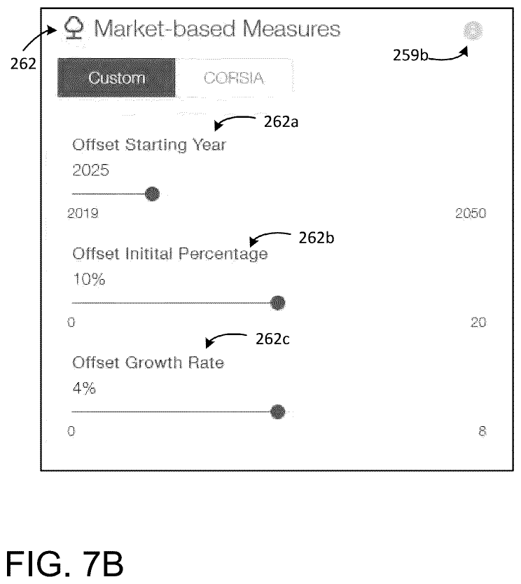

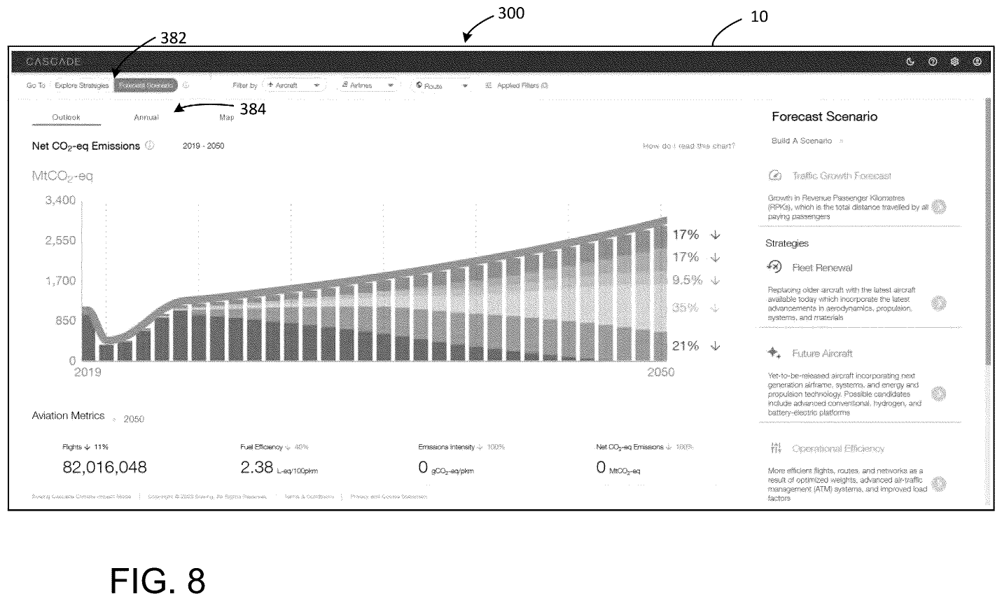

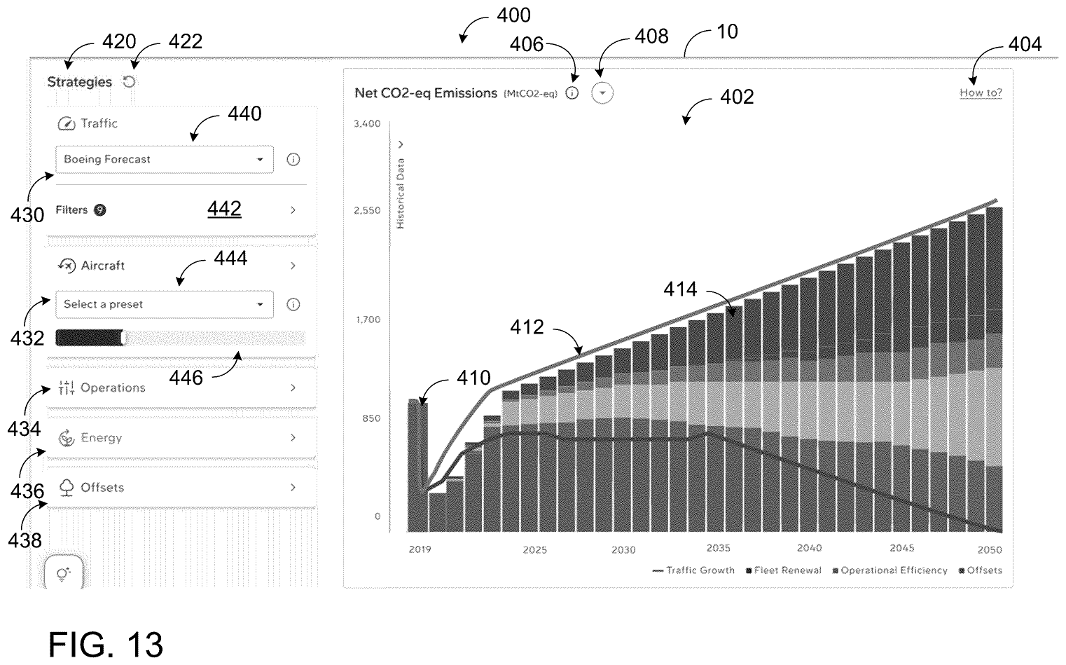

FIGS. 2A-5 illustrate various aspects of the GUI 100 in accordance with certain embodiments. FIGS. 6A-7B illustrate various aspects of another graphical user interface 200 (or GUI 200) in accordance with other embodiments. FIGS. 8-12C illustrate various aspects of yet another graphical user interface 300 (or GUI 300) in accordance with still other embodiments. FIGS. 13-20 illustrate various aspects of still another graphical user interface 400 (or GUI 400) in accordance with other embodiments. Each of GUI 100, GUI 200, GUI 300, and GUI 400 may be similar to one or more of the other GUIs in at least some respects. Accordingly, the following paragraphs will only describe the aspects of GUI 400, GUI 300, and GUI 200 that differ from GUI 100, for the sake of brevity.

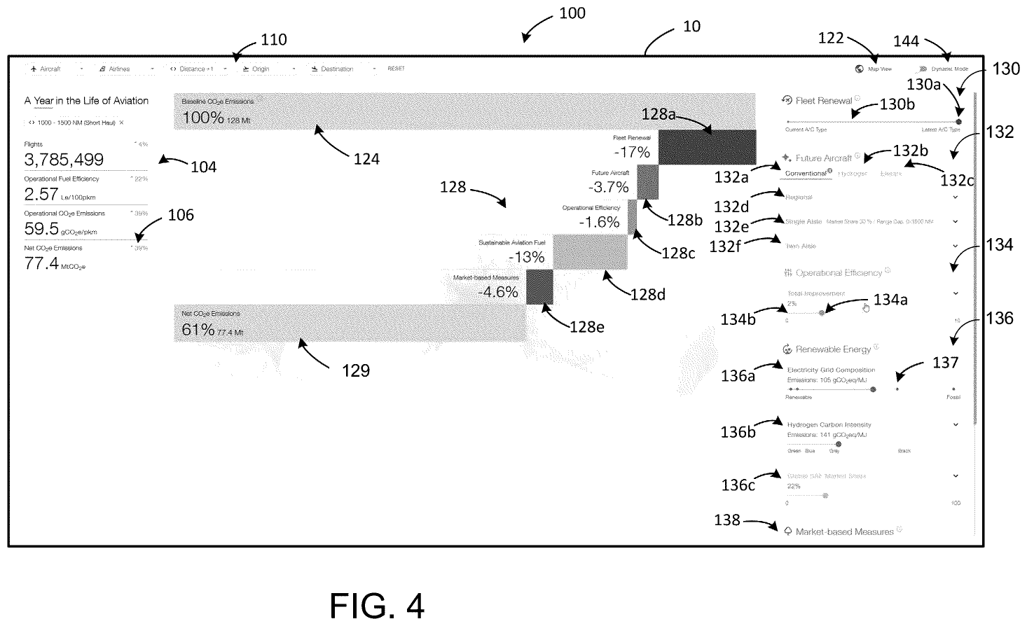

FIG. 1 specifically displays metrics for the flights 102 without user mitigation (e.g., application of sustainability strategies, selection of filter values, etc.) and thus, depicts baseline emission values for comparison of the impact of selected sustainability strategies. Once the user makes selections or inputs via the GUI 100, the values in table 104 will change to reflect those inputs, for example. Change indicators 106 (see, FIG. 4) may appear next to each metric, or data line, to indicate, e.g., in percentages, if/how the value changes compared to the baseline. The color and arrow direction of the change indicator may depict whether the change is positive or negative, compared to the baseline. For example, in the illustrated embodiment, a green, downward arrow represents a positive outcome (e.g., decrease) and a red, upward arrow represents a negative outcome (e.g., increase). If the user makes a selection that results in zero flights, the table 104 may display “0” for the number of flights and blanks or dashes for the remaining metrics.

As shown in FIG. 1, the GUI 100 also includes the phrase “A Year in the Life of Aviation” to indicate that the data in table 104 and the flights 102 shown on the map represent yearly data for a specific year or 12-month period. Referring additionally to FIGS. 2A through 3B, shown is an exemplary illustration of how the user can change the time period displayed in the map view by using a user-selectable time option 108 for switching or toggling between two or more time periods. In particular, when option 108 is set to “year” (i.e. as shown in FIG. 1), the GUI 100 is configured to display yearly data for the flights in a given year (e.g., February 2019 to February 2020, as shown in FIG. 2A). When the option 108 is set to “day,” the GUI 100 is configured to display daily data for the flights in a given day (e.g., Jan. 20, 2020, as shown in FIG. 3A). As would be expected, there is a stark difference in magnitude when comparing the number of yearly flights in FIG. 2B to the number of daily flights in FIG. 3B. Other changes in data may also appear, such as, e.g., the number of flight paths 102 displayed in the map and the amount of CO2 emissions displayed in the table 104. In other embodiments, the user-selectable time option 108 may be configured to allow selection of other time periods (e.g., week, month, etc.) in addition to, or instead of, the year and daytime periods. In some embodiments, changing the time option 108 from one value to the other may involve animation that mimics scrolling between values on a wheel, or other appropriate animation.

In some embodiments, the user-selectable time option 108 may be configured as shown in FIGS. 2A to 3B, where the text itself, e.g., “Year” or “Day,” is a user selectable option. In other embodiments, for example, the GUI 100 may include a user-selectable time option that is configured as a button, icon, or other graphic and is further configured to display a drop-down menu upon selection. For example, the time option may include an arrow or other symbol to include the presence of the drop-down menu. The drop-down menu can be configured to display or list a plurality of selectable time periods for changing or toggling the time period displayed in the map view, such as, e.g., a “Year” option and a “Day” option. Selecting one of the options causes the data displayed on the map view to change accordingly, as described above. Hovering over an option in the drop-down menu may cause that option to be highlighted. Once the user selects one of the drop-down options, the menu may automatically close or collapse and the newly selected option may be displayed in the time option icon. In both embodiments, hovering over the time option 108 may cause the corresponding time period (e.g., the calendar dates corresponding to the selected time period) to be displayed above the time option 108, for example, as pop-up text, a comment bubble, or the like, as shown in the figures.

As shown in FIG. 1, the GUI 100 further includes a plurality of filter options 110 across a top of the GUI 100, above the map view. These filter options 110 may be used to adjust a scope of the data being displayed and therefore, the flight paths 102 depicted on the map and the metrics listed in the table 104. In the illustrated embodiment, the filter options 110 may include an aircraft filter 112 for selecting a particular type of aircraft (or multiple types), an airlines filter 114 for selecting a particular airline, or multiple airlines, a distance filter 116 for selecting a particular distance, or distance range, for the flight paths 102, an origin filter 118 for selecting a particular origin or starting location for the flight paths 102, and a destination filter 120 for selecting a particular destination or ending location for the flight paths 102. There may be fewer flight paths 102 on display in the map and fewer number of flights listed in table 104 due to the filtering, or narrower scope of data. Other values displayed in the GUI 100 are also adjusted accordingly (e.g., other values in the table 104, etc.).

In some embodiments, for example, the airlines filter 114 can include a search bar, or other text input area, for enabling a user to enter a search term or phrase, such as, e.g., the name of a particular airline that the user wants to use for filtering the data. If no text is entered in the search bar, a list of all existing airlines may be displayed below the airlines filter 114 (e.g., as a drop-down menu), for example, upon selecting, or otherwise activating, the airlines filter 114 icon or graphic. Each airline name may be displayed as a separate user-selectable option that has, for example, a check box or other graphic configured to enable selection, or deselection, of the airline option. As the user enters the search term into the search bar, one or more matching airline options may appear in a list or drop-down menu below the search bar. The user can select one or multiple airline options for filtering purposes. The default filter setting may be selection of all airlines worldwide (i.e. no filtering). Thus, if none of the airline options are selected, the data displayed in the map view will not be filtered. In some cases, all of the airlines options may be pre-selected as a default filter setting, such that the user must de-select the airlines that they do not wish to include in the displayed data.

According to other embodiments, the GUI may include a plurality of filter options that are somewhat differ from the filter options 110. In particular, the filter options may include an aircraft filter with a user-selectable option (e.g., drop-down menu) for selecting one or more types of aircrafts, like the aircraft filter 112. The filter options may also include an airlines filter with a user input area for enabling the user to enter a search term or phrase, such as, e.g., the name of a particular airline, and/or a list of user-selectable airlines options, like the airlines filter 114. The GUI may include a route filter for selecting a particular route or region for filtering the plurality of flight paths 102 shown on the map. The route filter may be included in place of, or in addition to, the distance filter 116, the origin filter 118, and/or the destination filter 120, for example. In the illustrated embodiment, upon user selection of the route filter, the GUI is configured to provide (or display a drop-down menu comprising) two user-selectable options for filtering the flight paths, such as, e.g., a first option for selecting flights within, to, and from a single region, and a second option for selecting flights between two specific regions.

Referring back to FIG. 1, the GUI 100 also includes a user-selectable view option 122 for changing the map view to a chart view. The user-selectable view option 122 may include one or more icons, text, or any combination thereof for representing its underlying function. In some cases, selection of the option 122 may cause the map view to fade to the background, so that the chart view can be displayed on top of the map view, for example, as shown in FIG. 4. In other cases, the chart view may be displayed on the GUI 100 in place of the map view. The view option 122 may change to “map view” when the GUI 100 is configured to display the chart view, such that selection of the view option 122 would cause the chart view to be replaced with the map view.

As shown in FIG. 4, the chart view may include a baseline CO2 emissions graphic 124 that displays a baseline CO₂e emissions percentage (i.e. 100%) for the flight paths 102 displayed in the map view and a numerical baseline value for the same emissions data (e.g., 128 Mt). In embodiments, the baseline graphic 124 is a static gray bar that extends full length, or across an assigned area of the GUI 100, and remains as shown, even as other parts of the chart view change dynamically, as described herein.

The chart view may further include a plurality of user-selectable strategy graphics (also referred to as “levers”) configured to enable the user to select and/or adjust respective sustainability strategies for reducing CO2 emissions of the flight paths 102 selected in the map view. The strategy graphics are initially shown only as headlines with icons and short explanatory text below each. The chart view may display only the baseline graphic 124 and the initial headlines and/or text for the graphics until the user selects one of the strategy graphics or otherwise activates a given strategy.

As shown in FIG. 4, the chart view further includes a bar chart 128 (also referred to as a “waterfall chart”) configured to graphically depict a predicted impact on CO2 emissions for each sustainability strategy selected using the strategy graphic. The bar chart 128 may include a one or more colored bars for visually representing the reduction in CO2 emissions caused by introduction of the corresponding sustainability strategy, as described herein. The bar chart 128 may appear once the user selects one of the strategy graphics and/or adjusts a parameter of the selected graphic.

Once the bar chart 128 is displayed, a net emissions graphic 129 may be displayed below the bar chart 128 in order to show the overall remaining CO2 emissions, or net CO2 emissions, after implementing the selected sustainability strategy. The net emissions graphic 129 may be presented as a gray bar, like the baseline graphic 124, with a length or size selected based on the net amount of emissions remaining after introduction of the selected strategy. For example, a length of the gray bar shown in the net emissions graphic 129 plus the lengths of any colored bars in the bar chart 128 may equal a total length of the gray bar shown in the baseline graphic 124. The net emissions graphic 129 may also include a textual display of a numerical percentage value and a total amount (in Mt) of the reduction. The GUI 100 may also dynamically display or depict the CO2 emissions impact of the selected strategies in other areas as well, such as, e.g., the metrics shown in the table 104.

In various embodiments, each of the strategy graphics includes a slider for selecting and/or adjusting one or more parameters associated with the corresponding sustainability strategy. In general, the sliders are configured to provide visual indication of adjustable content associated with the reduction strategies and enable the user to increase or decrease the parameter values by moving the slider along a horizontal scale or track. In embodiments, each slider is associated with a corresponding bar of the bar chart 128, as shown in FIG. 4, such that adjusting the sliders has a direct and dynamic effect on the bar chart 128. For example, each of the bars of the bar chart 128 may be configured to increase or decrease in size (or emissions reduction value) depending on the parameter value selected for the corresponding strategy using the associated slider. The bar chart 128 may also be configured to display the actual reduction in CO2 emissions caused by each strategy as a numeric percentage or other numeric value. In other embodiments, other input devices may be used in place of the sliders, such as, e.g., for example, user-selectable buttons, radio buttons, dials, drop-down menus, data entry fields, and more. Such input devices can be similarly linked to the bar chart 128 in order to directly and dynamically depict the CO2 emissions impact of each strategy.

As shown in FIG. 4, the plurality of strategy graphics and the bar chart 128 may be color coded, so that the impact of each strategy, or the connection between inputs and outputs in the chart view, is easily discernible to the user. For example, each strategy graphic may be assigned a different color, and the sub-strategies belonging to the same category may be presented in the same color. While a specific color code may be shown in the figures, it should be appreciated that other colors, or color codes, may be used instead, in accordance with the principles described herein. In some embodiments, the GUI 100 may use shading instead of colors, or other types of codes for visually connecting the strategy selections to the emissions impacts.

In the illustrated embodiment, the plurality of strategy graphics may include a fleet renewal graphic 130, a future aircraft graphic 132, an operational efficiency graphic 134, a renewable energy graphic 136, and a market-based measures graphic 138. In other embodiments, the strategy graphics may include other and/or additional graphics for representing alternative and/or additional sustainability strategies.

According to embodiments, the fleet renewal graphic 130 may be configured to enable the user to see the emissions impact of replacing older aircraft (or “A/C”) with the latest aircraft available, such as, e.g., aircraft that incorporates the latest advancements in aerodynamics, propulsion, systems, and materials. For example, as shown in FIG. 4, the fleet renewal graphic 130 may be configured to allow user-selection of a desired strategy for fleet renewal by providing a first user-selectable slider 130a, or other input device, that is movable along a first scale 130b having a first parameter value corresponding to current or older aircrafts (e.g., “current A/C type”) and a second parameter value corresponding to newer or latest aircrafts (e.g., “latest A/C type”). The location of the fleet renewal slider 130a on the first scale 130b may indicate the amount of latest aircraft technology that will be part of the user's fleet renewal strategy. For example, placing the slider 130a at the first parameter value indicates no fleet renewal, while placing the slider 130a at the second parameter value (i.e. as shown in FIG. 4) indicates a complete fleet renewal. In some embodiments, moving the fleet renewal slider 130a to the middle of the scale 130b may indicate selection of a fleet that is comprised of about 50% current technology aircraft and about 50% latest technology aircraft.

As shown in FIG. 4, a first colored bar 128a of the bar chart 128 may be configured to display the CO2 emissions impact, or a reduction in the CO2 emissions percentage, that is caused by the fleet renewal strategy selected using graphic 130 (e.g., selection of current A/C, latest A/C, or a combination thereof). For example, the first bar 128a may have a size that directly correlates to, or represents, the amount of emissions reduction caused by the selected fleet renewal strategy. A numerical representation of the resulting reduction in CO2 emissions (e.g., percentage of reduction) may also be displayed, as illustrated. The first bar 128a may be colored a first color to match a first color of the fleet renewal graphic 130 (e.g., purple).

The future aircraft graphic 132 may be configured to enable the user to see the emissions impact of incorporating future or next generation airframe, systems, and energy and propulsion technology that may be more climate-friendly than existing technologies. According to embodiments, the future aircraft graphic 132 may include a plurality of tabs for selecting different types of future technology. For example, in the illustrated embodiment, the future aircraft graphic 132 includes a conventional tab 132a for selecting advanced conventional aircraft technology, or aircraft that burn jet fuel for propulsion but with increased efficiency; a hydrogen tab 132b for selecting a hydrogen platform, or aircraft that burn hydrogen for propulsion; and an electric tab 132c for selecting a battery-electric platform, or aircraft that use electricity for propulsion.

The future aircraft graphic 132 also includes a plurality of drop-down or expandable options (or “cards”) for specifying or selecting certain parameters associated with the selected technology tab 132a, 132b, or 132c. In the illustrated embodiment, the expandable options are for selecting aircraft types, such as, for example, a regional aircraft option 132d, a single-aisle aircraft option 132e, and a twin-aisle aircraft option 132f, e.g., as shown in FIG. 4. In some cases, one or more of the aircraft options will be removed if the selected technology tab does not support or have the aircraft option(s). For example, when the electric tab 132c is selected, only the regional aircraft option 132d may be shown, whereas all three options 132d, 132e, and 132f may be displayed for the conventional tab 132a and the hydrogen tab 132b.

Selecting one of the options 132d, 132e, or 132f may cause the GUI 100 to display additional sliders for selecting and/or adjusting specific parameter values associated with the selected aircraft type. For example, a market share slider may be displayed and configured for selecting the percentage or number of older aircraft that will be replaced by the selected type and size of newer aircraft (e.g., 0 to 100%). A range capability slider may also be displayed for indicating the distance that the selected aircraft can travel (e.g., 0 to 1000 NM). The values displayed on the scale associated with the range capability slider may vary depending on the selected aircraft.

The dynamic tool may be configured to calculate the change in CO2 emissions due to the selected future aircraft strategy by determining the number of future aircraft flights that will be required to replace historic or current flights. This determination may take into account the seat count and flight frequency of current flights to determine how many future aircraft flights will be needed to replace the same number of seats. In addition, the number of historic seats that will be replaced may be computed based on the user-defined market share, i.e. as selected using a market share slider.

The above calculation assumes that current aircrafts of regional size will be replaced with future aircrafts of regional size. In order to allow the user to change the future aircraft size, the market share slider may be associated with one or more sub-sliders that may be displayed (or drop-down) upon expanding the market share slider. The sub-sliders may be used to change the market share for the selected aircraft size, or the number of flights being carried out by the selected aircraft size, or other parameters associated therewith. A first sub-slider may be for selecting a market share for single aisle aircraft, and a second sub-slider may be for selecting a market share for twin-aisle aircraft. The values selected using the sub-sliders may be reflected in the future aircraft graphic 132 next to the corresponding option 132d, 132e, and/or 132f, for example, as shown in FIG. 4.

As shown in FIG. 4, a second colored bar 128b of the bar chart 128 may be configured to display the CO2 emissions impact of the future aircraft strategy selected using graphic 132 (e.g., selection of conventional, hydrogen, or electric technology, and specific parameters for each). For example, the second bar 128b may have a size that directly correlates to, or represents, the amount of emissions reduction caused by the selected future aircraft strategy. A numerical representation of the resulting reduction in CO2 emissions (e.g., percentage of reduction) may also be displayed, as illustrated. The second bar 128b may be colored a second color to match a second color of the future aircraft graphic 132 (e.g., blue).

The operational efficiency graphic 134 may be configured to enable the user to see the emissions impact of having more efficient flights, routes, and networks as a result of optimized weights, advanced air-traffic management (“ATM”) systems, and improved load factors, for example. The operational efficiency graphic 134 may be configured to allow user-selection of a desired amount of total improvement by providing a second user-selectable slider 134a, or other input device, that is movable along a second scale 134b having a first parameter value corresponding to zero, or no improvement of current conditions, and a second parameter value corresponding to ten, or maximum improvement of current conditions. Thus, the location of the operational efficiency slider 134a on the second scale 134b may indicate the amount of operational efficiency improvement that will be part of the user's strategy.

As shown in FIG. 4, a third colored bar 128c of the bar chart 128 may be configured to display the CO2 emissions impact of the operational efficiency strategy selected using graphic 134 (e.g., the amount of improvement selected). For example, the third bar 128c may have a size that directly correlates to, or represents, the amount of emissions reduction caused by the selected operational efficiency strategy. A numerical representation of the resulting reduction in CO2 emissions (e.g., percentage of reduction) may also be displayed, as illustrated. The third bar 128c may be colored a third color to match a third color of the operational efficiency graphic 134 (e.g., red).

The renewable energy graphic 136 may be configured to enable the user to see the emissions impact of using energy and/or fuel that is derived from non-fossil pathways. Exemplary forms of renewable, on-board energy storage may include sustainable aviation fuels, green hydrogen, batteries, and/or others. As shown in FIG. 4, the graphic 136 may include a plurality of user-selectable sliders disposed on respective scales for selecting parameter values for different types of renewable energy and/or fuel, such as, for example, an electricity grid composition slider 136a for selecting whether the electricity used is derived from all renewable resources, all fossil-based resources, or some combination thereof. The graphic 136 may also include a hydrogen carbon intensity slider 136b for selecting whether the hydrogen source is green, blue, gray, or black. The graphic 136 may also include a global SAF market share slider 136c for selecting a global or total market share (e.g., 0 to 100%) for aircraft that use sustainable aviation fuels.

As shown in FIG. 4, one or more of the sliders, such as, e.g., the electricity grid composition slider 136a, may include a plurality of markers 137 disposed at various locations along the scale for indicating certain parameters or values. In some embodiments, the one or more sliders, such as, e.g., an electricity grid composition slider, may be configured to display descriptive text when the user hovers over a given marker, or moves the slider to the marker position.

As shown in FIG. 4, a fourth colored bar 128d of the bar chart 128 and may be configured to display the CO2 emissions impact of the renewable energy strategy selected using graphic 136 (e.g., relative selections for renewable electric energy sources, green hydrogen, or SAF). For example, the fourth bar 128d may have a size that directly correlates to, or represents, the amount of emissions reduction caused by the selected renewable energy strategy. A numerical representation of the resulting reduction in CO2 emissions (e.g., percentage of reduction) may also be displayed, as illustrated. The fourth bar 128d may be colored a fourth color to match a fourth color of the renewable energy graphic 136 (e.g., yellow).

The market-based measures graphic 138 may be configured to enable the user to see the emissions impact of market-based measures, such as, for example, carbon offsets, which reduce or remove greenhouse gases from sectors outside of aviation to offset the emissions produced by aviation. In some cases, the carbon offsets may be due to implementing climate-friendly routing for a significant portion of the fleet in a short amount of time.

As shown in FIG. 4, a fifth colored bar 128e of the bar chart 128 and may be configured to display the CO2 emissions impact of the market-based measures strategy selected using graphic 138. For example, the fifth bar 128e may have a size that directly correlates to, or represents, the amount of emissions reduction caused by the selected market-based measures strategy. A numerical representation of the resulting reduction in CO2 emissions (e.g., percentage of reduction) may also be displayed, as illustrated. The fifth bar 128e may be colored a fifth color to match a fifth color of the market-based measures graphic 138 (e.g., green).

In various embodiments, the dynamic display tool may be configured to depict dependency between a certain combination of sustainability strategies (or levers), such as, for example, dependency between fleet renewal and future aircraft, fleet renewal and sustainable aviation fuel, fleet renewable and operational efficiency, renewable energy and sustainable aviation fuel, renewable energy and future aircraft, and/or future aircraft and operational efficiency. For example, adjusting the future aircraft graphic 132 to include more latest aircraft technology may automatically change an outcome (e.g., amount of CO2 emissions) of the renewable energy graphic 136, as well as the percentage number displayed in association therewith, because of the dependency between the two strategies. In particular, using more latest technology aircraft may reduce the impact of electric aircraft or other future aircraft types at least because the latest technology aircraft may be more fuel efficient than the conventional aircraft that they are replacing. The dependencies may be shown as automatic changes to the CO2 emissions data being displayed on the GUI 100 (e.g., in the bar chart, as metrics, in sliders, etc.), or in any other suitable manner, as will be appreciated.

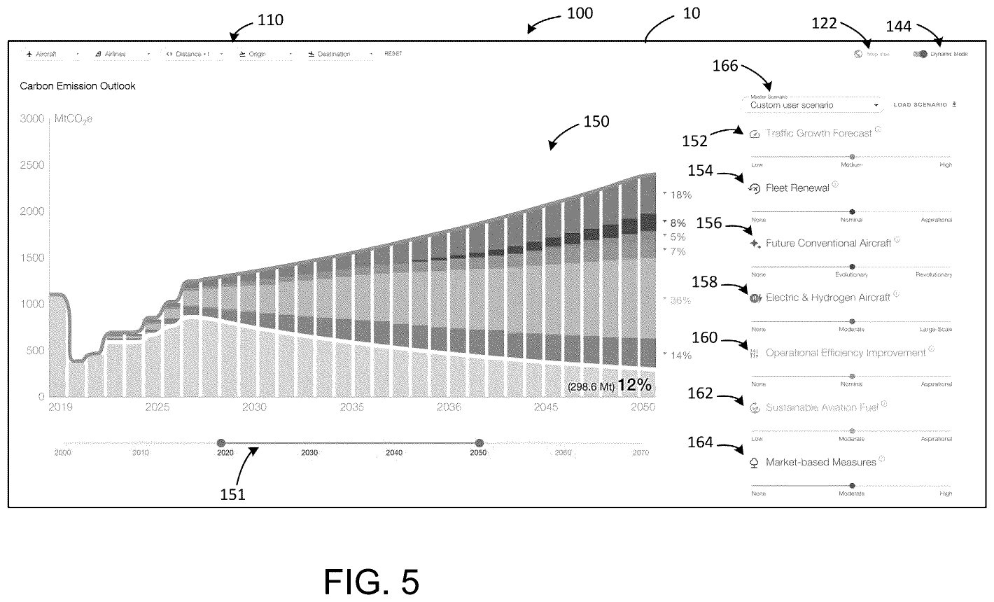

In various embodiments, the GUI 100 further includes a dynamic mode option 144 for changing from the map view or chart view to a dynamic mode of the GUI 100, for example, as shown in FIG. 5. The dynamic mode option 144 may be a slider-type button or other input device for toggling or turning the dynamic mode on and off. When the dynamic mode is selected (e.g., option 144 is slid to the right), the map view/chart view may be replaced with a carbon emission outlook graph 150, as shown in FIG. 5. When the dynamic mode is unselected (e.g., option 144 is slid to the left), the graph 150 may be replaced with the chart view or the map view, depending on which view was last selected via the view option 122 and/or which view is currently reflected by the view option 122 (e.g., the map view in FIG. 5).

As shown in FIG. 5, the carbon emissions outlook graph 150 graphically depicts the impact of various measures, or sustainability strategies, on the reduction of carbon emissions, or CO2 emissions, over a select period of time. The measures may be based on preselected and/or user-selected scenarios, and their impact may be depicted using stacked colored bars for each year. The colored bars may be stacked on top of a gray bar that represents the remaining CO2 emissions for that year. The select period of time may be pre-selected or user-selected, for example, using a time-select slider 151 as shown in FIG. 5, and may include past and/or future time periods. Thus, the graph 150 can be configured to graphically and dynamically depict the emissions trend, or outlook, over a number of years for selected scenarios.

In various embodiments, the carbon emissions outlook graph 150 may be configured to display carbon emissions information for measures that are the same as, similar to, based on, or otherwise associated with the sustainability strategies shown in the chart view, and may use the same, or similar, color coding as the chart view for consistency and ease of connection. The measures depicted in the graph 150 may be represented by a corresponding lever that operates like the levers shown in FIG. 4, and described herein, to adjust or configure one or more parameters associated with the underlying measure. While the levers are shown as sliders in the depicted embodiments, it should be appreciated that other input mechanisms may be used to enable user configuration of the sustainability strategies and measures described herein.

As shown in FIGS. 4 and 5, the GUI 100 may include, for example, a traffic growth forecast lever 152 that may be set to low, medium, or high using a traffic growth slider; a fleet renewal lever 154 that may be associated with the fleet renewal graphic 130 and may be set to none, nominal, or aspirational using a fleet renewal slider; a future conventional aircraft lever 156 that may be associated with the conventional aircraft option 132a and may be set to none, evolutionary, or revolutionary using a conventional slider; an electric and hydrogen aircraft lever 158 that may be associated with the electric aircraft option 132c and the hydrogen aircraft option 132b and may be set to none, moderate, or large-scale using an electric and hydrogen slider; an operational efficiency improvement lever 160 that may be associated with the operational efficiency graphic 134 and may be set to none, nominal, or aspirational using an efficiency slider; a sustainable aviation fuel lever 162 that may be associated with the global SAF market share slider 136c and may be set to low, moderate, or aspirational using an SAF slider; and a market-based measures lever 164 that may be associated with the market-based measures graphic 138 and may be set to none, moderate, or high using a market slider.

In some embodiments, the GUI 100 may also include, in the dynamic mode, a master scenario option 166 configured to allow the user to select a particular scenario for which carbon emissions data is displayed on the graph 150. Each scenario includes specified selections, or slider settings, for each of the levers (or underlying measures) and/or certain parameters associated therewith. The scenarios may be manually entered by the user or uploaded from a saved file (e.g., using the “load scenario” option). In FIG. 5, the depicted measures have been configured according to a custom user scenario that sets median values, or slider settings, for each of the levers. When a new scenario is entered via adjustment of a measure or parameter value, or other change in data scope, the carbon emissions data may be re-calculated and the graph 150 updated accordingly.

In other embodiments, each of the depicted measures, or strategies, may have a master lever for limited configuration of the corresponding measure, and a number of the master levers may have one or more corresponding detailed levers, or sliders, for more nuanced configuration of the corresponding measure, as shown by GUI 200 in FIGS. 6A to 7B. The GUI 200 can be configured to include an overview 201 that displays or lists all available master levers, as best seen in FIG. 6B. In the illustrated embodiments, the GUI 200 includes six master levers, namely: a traffic growth forecast lever 252, fleet renewal lever 254, future aircraft lever 256, operational efficiency lever 258, renewable energy lever 260, and market-based measures lever 262, similar to the corresponding levers of GUI 100. As shown, each of levers 252, 254, 256, 258, 260, and 262 are set to a default position 257 (e.g., moderate). In other embodiments, the GUI 200 may include more or fewer master levers, and/or may include other master levels in addition to the master levels shown, as will be appreciated.

As shown in FIGS. 7A to 7B, one or more of the master levers may be configured to display a detailed view, or corresponding detailed lever(s), upon user selection of the master lever, or other aspect of the GUI 200. In some embodiments, for example, as shown in FIG. 6B, each master lever with more settings can be configured to display a user-selectable “more options” or “detail settings” icon 259 that is placed adjacent to, or above, the corresponding slider, and is configured to display the detailed levers in response to user selection of the icon 259. For example, selection of the icon 259 for a given master lever may cause the master lever to expand into or otherwise reveal detailed levers. In some cases, the detailed levers may be displayed in place of, or below, the master lever, and may cause the other master levers to shift down or up, as needed, to accommodate the detailed levers, as shown in FIG. 7A, for example. In other cases, selection of the icon 259 may cause display of a drop-down menu that includes the detailed levers and at least partially overlaps with one or more other levers. The detailed levers may be arranged vertically, or stacked on top of each other, for example, as shown in FIG. 7B, or in any other suitable arrangement. In the illustrated embodiment, for example as best seen in FIG. 6B, all of the levers except the fleet renewal lever 254 include the icon 259 because the fleet renewal lever 254 does not have associated detailed levers. The fleet renewal lever 254 can be adjusted using the corresponding slider displayed in the lever overview menu 201. In other embodiments, the fleet renewal lever 254 may also be configured to include one or more detailed levers and thus, may include the icon 259.

For improved usability, hovering over the more options icon 259 may cause descriptive text, such as, e.g., “Detail Settings,” to be displayed above or adjacent to the icon 259, for example. When in the detailed levers view, the more options icon 259 may be replaced with a return icon 259b for enabling the user to return back to the master overview 201, for example, as shown in FIG. 7B. As also shown, descriptive text, such as, e.g., “Back to Master,” may be displayed above or adjacent the icon 259b, for example, when the user hovers over the icon 259b. As another example, according to embodiments, the GUI 300 may be configured to display explanatory text in a pop-up window, or other appropriate interface, when the user hovers over a given prompt, such as, e.g., “How do I read this chart?”.

The master lever can be configured to enable the user to assess the impact of the corresponding strategy based on generalized settings, such as, e.g., “Low,” “Moderate,” and “High,” as shown by GUI 200 in FIG. 6A. In the illustrated embodiment, all of the master levers are set to “Moderate,” or other median value, as a default setting. From there, the user may move a slider of a given master lever left towards the “Low” setting, or right towards the “High” setting, as desired. In this manner, the master levers can be manipulated by novice or inexperienced users without needing detailed knowledge about the underlying logic to understand and use the sliders.

In some embodiments, the master levers may be mapped to the detailed levers to enable more experienced, or expert, users to customize one or more advanced settings for the corresponding measure. In some cases, the detailed levers enable user selection of a specific numerical value or range, while the corresponding master lever has generic or categorical settings (e.g., Low, Moderate, High), for example. As shown in FIGS. 7A and 7B, the exact type of detailed lever(s) provided for each master lever may vary depending on the type of measure represented by the corresponding master lever.

In some embodiments, the detailed-levers view may include tabs or other user-selectable options for switching between different scenarios or modes of calculation, such as, e.g., a custom scenario (e.g., via selection of “Custom” option), a fixed or precomputed scenario (e.g., via selection of “BoeingCMO” option, or carbon offsetting and reduction scheme for international aviation (CORSIA) option in FIG. 7B), and/or one or more other scenarios, such as, e.g., a scenario that displays a different set of detailed levers, other proprietary scenario, a user's preset forecast or scenario, etc. As shown in FIGS. 7B, for example, when the custom mode is selected, the detailed levers 262a, 262b, and 262c can be configured to enable a user to customize the settings of the selected scenario, or otherwise create a new scenario, for example, by allowing adjustment of one or more of the detailed levers. When the precomputed mode is selected, the detailed levers may be set to preselected values that correspond to a preset sustainability scenario and may be configured to prevent the user from adjusting the lever settings further (e.g., as shown by a grayed out, or unselectable, slider).

In some embodiments, each detailed lever may be configured to enable the user to adjust the corresponding setting across its full range (e.g., 0 to 100%), while each master lever may be configured to enable user adjustment of the corresponding measure within a limited range (e.g., 20 to 80%). For example, the master lever scale may have a smaller numerical range than the scale(s) of its detailed lever(s). Such configuration may facilitate and improve a user's understanding of the carbon emissions outlook graph 150 and related materials, for example, by reducing the number of tick marks shown on the scales in the master overview 201. However, since the detailed levers have a wider range than the underlying master lever, the scale of a given master lever may not encompass the values selected for its corresponding detailed lever(s). In such cases, the master lever may be configured to indicate an out-of-bounds selection on its slider, for example, by including an arrow on a far-left end of the slider scale. As also shown, a given master lever may include a reset option that is displayed on or near the slider for resetting the master lever to a default value. According to some embodiments, for example, the GUI 300 may include a master reset option (or “Reset Scenario”) configured to enable the user to reset all sliders or strategies to default values. In such cases, the reset option may remain inactive or grayed out when no filter options are selected or activated and may change to colored and/or selectable format after one or more filter options are selected or implemented.

In some cases, the arrow may be displayed on the left-side of the master slider when one or more of its detailed levers is below a lower boundary of the corresponding master lever. In other cases, the out-of-bounds arrow may be displayed on a far-right end of the slider scale, for example, to indicate selection of custom settings that go beyond the high end of the master lever range. In cases where the detailed levers are a mix of in-range and out-of-range values, the GUI 200 may be configured to determine which of the detailed levers has the largest impact on the corresponding measure, or is the most dominate factor, and may use the location of that detailed lever to select a corresponding location for the slider of the master lever.

According to other embodiments, as shown in FIG. 8, the GUI 300 may be configured to display detailed data, or aviation metrics, for a selected year in a summary table that is presented below a carbon emissions chart of an outlook view presented in the forecast scenario view. That is, instead of displaying the pop-up window 255 on top of the chart 250, the GUI 300 can display the same, or similar data, in a fixed table that does not overlap with, and possibly block view of, the carbon emissions chart. The data displayed in the summary table may be automatically updated each time a new year is selected, e.g., using one of the user-selectable bars of the chart.

The GUI 300 may include user-selectable navigation options 380 for switching between, or selecting either of, an explore strategies view and a forecast scenario view, to allow the user to easily transition between the two sections of the GUI 300, without going back to the welcome screen, for example. As also shown in FIG. 8, the explore strategies view of the GUI 300 may include user-selectable view options 382 for toggling between, or respectively selecting, a chart view and a map view that corresponds to the chart view (or vice versa).

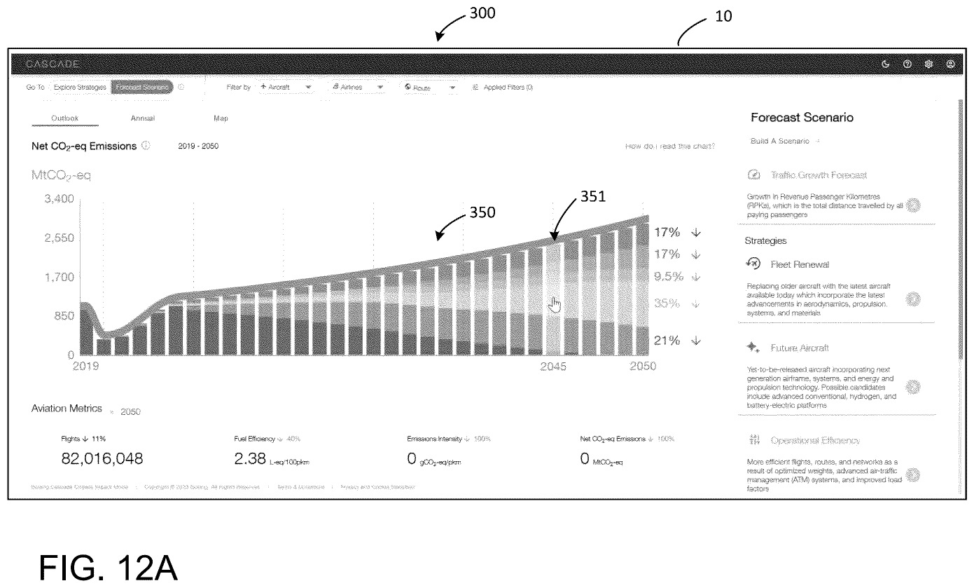

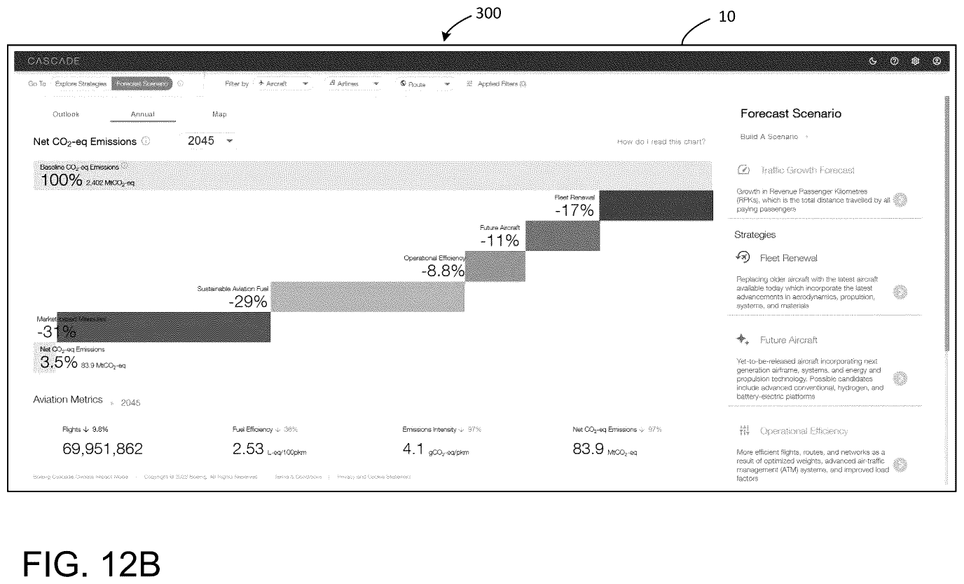

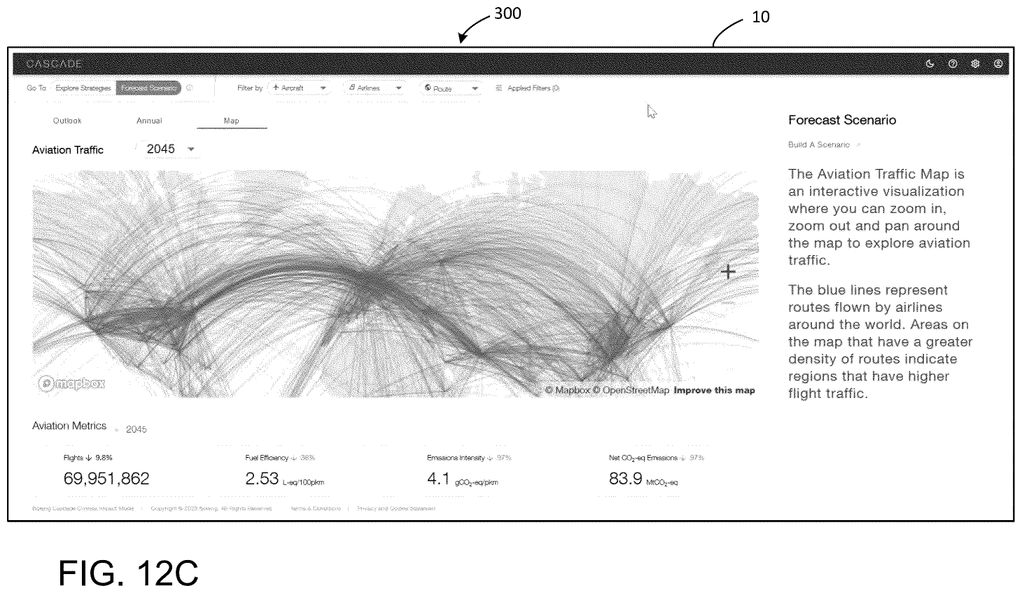

As shown in FIG. 8, the forecast scenario view of the GUI 300 may include a second set of user-selectable view options 384 for toggling between, or respectively selecting, an outlook view, an annual view, and a map view that corresponds to the annual view (or vice versa). For example, the annual view shown in FIG. 12B corresponds to the map view shown in FIG. 12C, and the user may move or toggle between the two views by selecting the appropriate view option 384. In embodiments, the outlook view may be configured to show CO2 emissions and other related data for a plurality of years (e.g., 2019 to 2050), while the annual and map views may be configured to show the same types of data for an individual year. The user may select the year that is displayed in the map view and/or the annual view by clicking or otherwise selecting a desired year in the outlook view.

For example, as shown in FIG. 12A, the GUI 300 may be configured to display, in the outlook view, a carbon emissions chart 350 comprised of a plurality of vertical bars 351, or columns, similar to the carbon emissions chart 250, for example. Each bar 351 may be configured to graphically represent CO2 emissions data for a respective one of the years represented in the chart 350 (e.g., from 2019 to 2050). In addition, each of the bars 351 may be configured to be user-selectable in order to allow the user to view more detailed information about the corresponding year upon hovering over, clicking on, or otherwise selecting the bar 351. For example, in the illustrated embodiment, user selection of the bar 351 representing the year 2045 causes the GUI 300 to switch from the outlook view shown in FIG. 12A to the annual view shown in FIG. 12B, which displays CO2 emissions data for the year 2045, as well as other related information.

FIGS. 13 to 19B show aspects of GUI 400 that may be employed to allow a user to provide detailed inputs to generate modeling strategies for reducing aircraft emissions over time. GUI 400 allows users to input physical parameters that define technology evolution and market evolution over time. The input parameters are then used to drive the behavior of one or more models that use the global database of flight parameters and aviation emissions information to model and forecast aviation emissions information over time. Preset parameters may be used to more abstractly define a level of ambition that a user may aspire to in reducing aviation emissions over time. The level of ambition may correspond to a level of investment, policy support, technological innovation, etc. in a particular area.

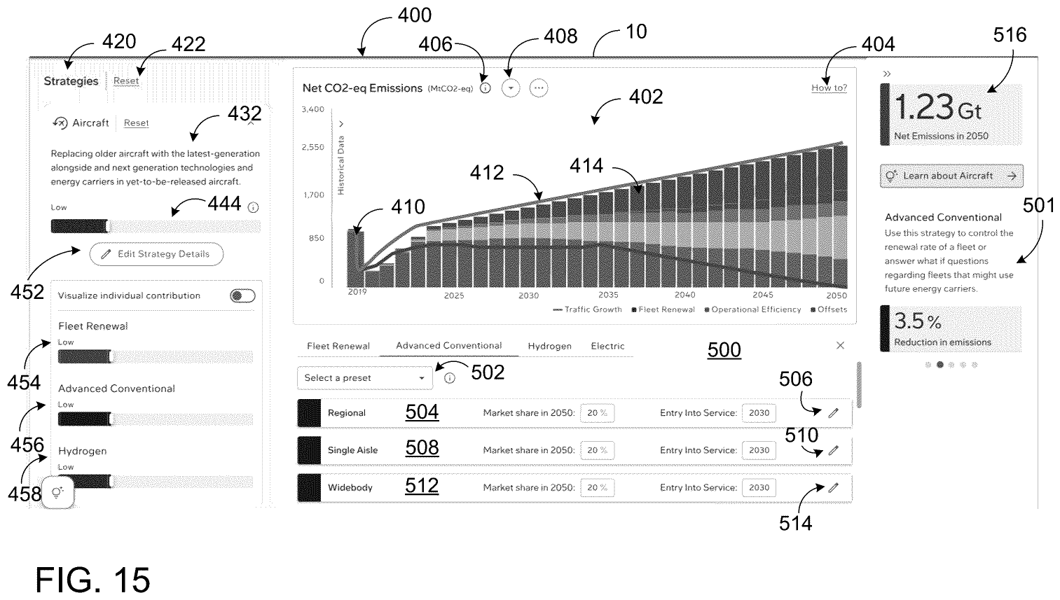

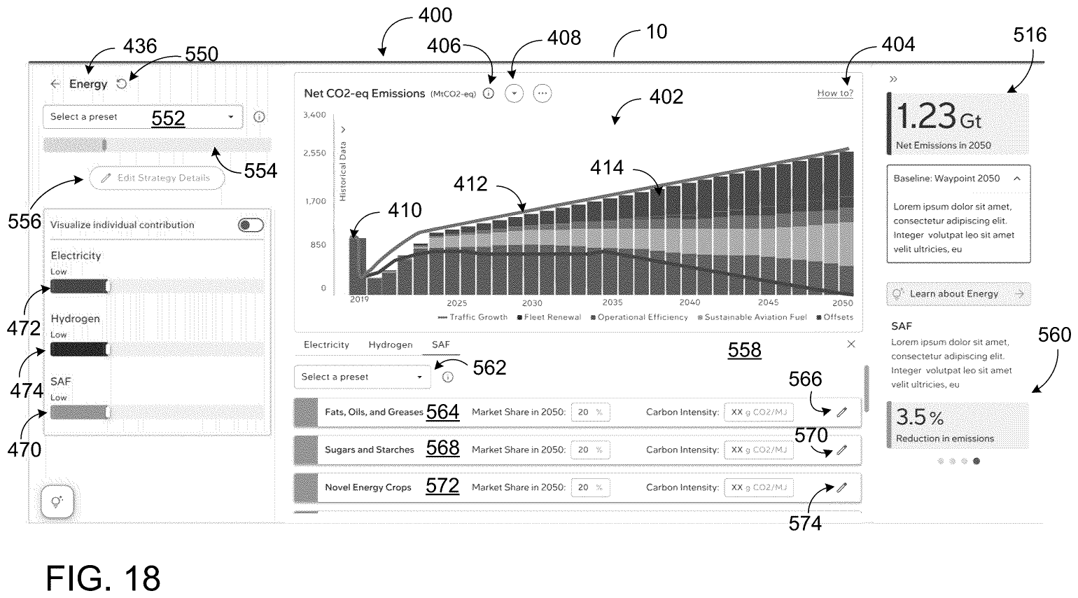

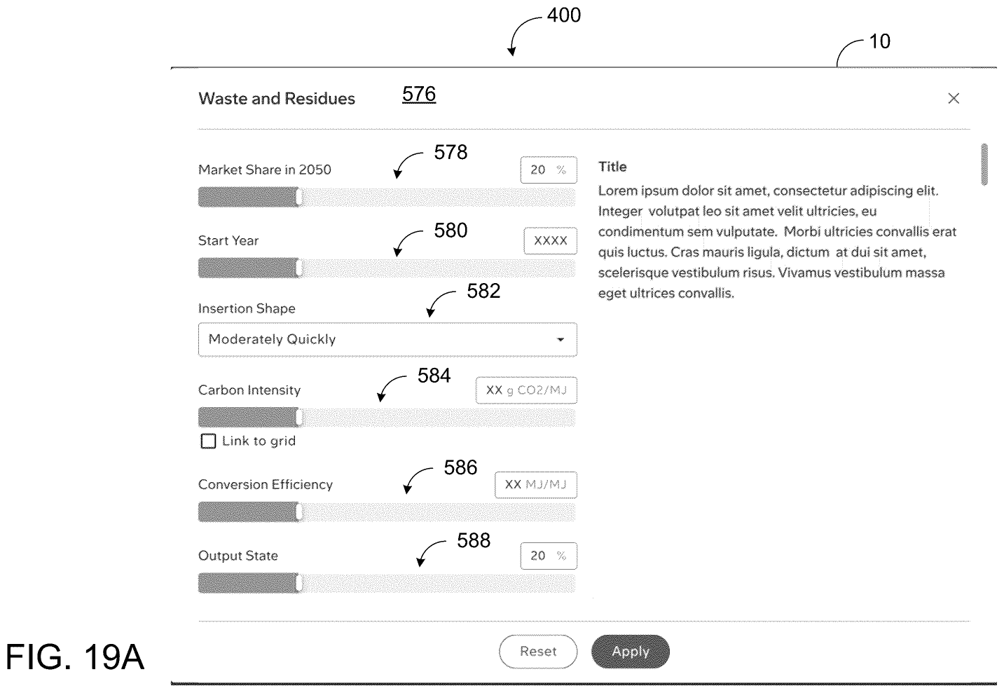

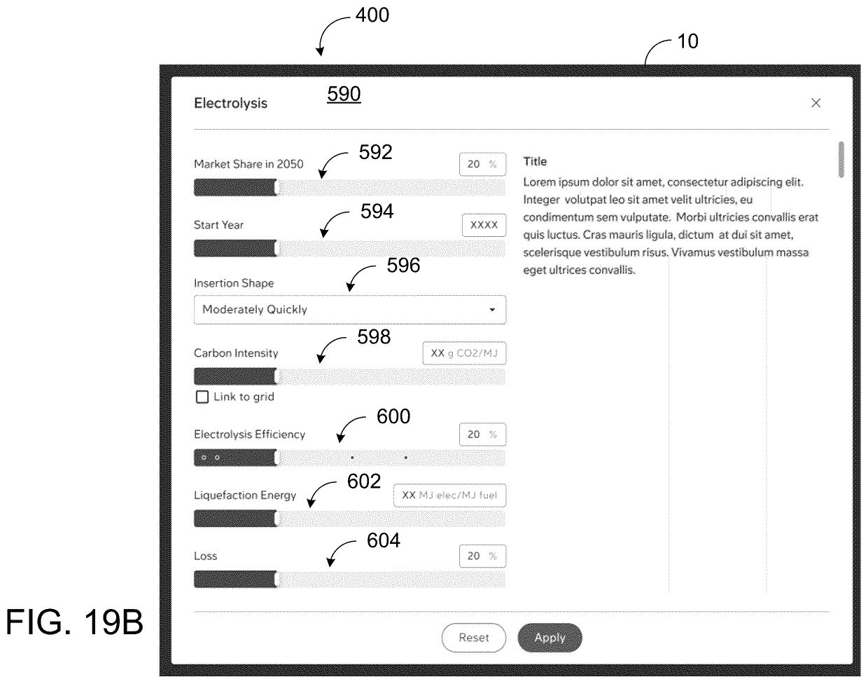

Each modeling strategy may thus be usable by users with broad ranges of expertise in order to generate strategies and roadmaps for reducing aviation emissions over time. GUI 400 thus allows for users to input low level details and implementation-level parameters while maintaining a highly approachable interface akin to GUIs 100, 200, and 300. Herein, FIGS. 15-17 visualize approaches for implementing modeling strategies for aircraft type evolution, and FIGS. 18-19B visualize approaches for implementing modeling strategies for renewable aircraft energy sources. Other approaches that are not shown include modeling strategies for aircraft operational efficiency, market-based carbon removals and carbon offsets, economics, policy, etc.

FIG. 13 shows an example GUI 400 presented on display device 10. GUI 400 is shown presenting a Net CO2-eq emissions graph 402, depicting the impact of various measures, or sustainability strategies, on the reduction of carbon emissions, or CO2-equivalent emissions, over a select period of time. The measures may be based on preselected and/or user-selected scenarios, and their impact may be depicted using stacked colored bars for each year. The colored bars may be stacked on top of a gray bar that represents the remaining CO2 emissions for that year. The select period of time may be pre-selected or user-selected. GUI 400 includes help buttons 404 and 406. In response to user interaction with help buttons (e.g., clicking, hovering), additional information may be displayed to the user. Other views and graphs may be accessed by user interaction with toggle button 408.

Net CO2-eq emissions graph 402 includes aspects of aviation emissions information 410 based on flight parameters for a plurality of flights over a time period stored in a global database. Aspects of aviation emissions information 410 may be based on a default model. Net CO2-eq emissions graph 402 further includes forecasted aviation emissions information 412 and modeled aviation emissions information 414. GUI 400 thus co-visualizes the modeled aviation emissions information 414 with aspects of aviation emissions information 410.

Forecasted aviation emissions information 412 and modeled aviation emissions information 414 are generated through one or more modeling strategies 420. GUI 400 presents a reset button 422 that may be used to restore strategic parameters of modeling strategies 420 to a default model. In this example, modeling strategies 420 include traffic forecast 430, aircraft type evolution 432, aircraft operational efficiency 434, aircraft energy sources 436, and market-based offsets 438. Each modeling strategy may comprise one or more strategy aspects that impact aviation emissions information over time. Each modeling strategy may be assigned a color or pattern that corresponds with data presented in net CO2-eq emissions graph 402 (e.g., traffic forecast 430 is shown in teal, aircraft type evolution 432 is shown in purple, aircraft operational efficiency 434 is shown in red, aircraft energy sources 436 is shown in yellow, and market-based offsets 438 is shown in green.)

As shown, strategic parameters for one or more modeling strategies may be shown in GUI 400. In this example, traffic forecast 430 is associated with forecast dropdown menu 440 and filters 442, while aircraft type evolution 432 is associated with preset evolution strategies dropdown menu 444 and an ambition lever 446. Dropdown menu 440 may allow the user to select one of a number of preset traffic forecasts indicating expected air traffic over a period of time (e.g., year-to-year growth). As such, a user may select from one or more preset input values for each strategic parameter. The user may also provide user input indicating input values for one or more strategic parameters of the one or more modeling strategies. For example, the ambition level may be set along a continuum of values. The strategic parameters are then applied to the global database of flight parameters to generate modeled emissions information 414 and forecasted aviation emissions information 412.

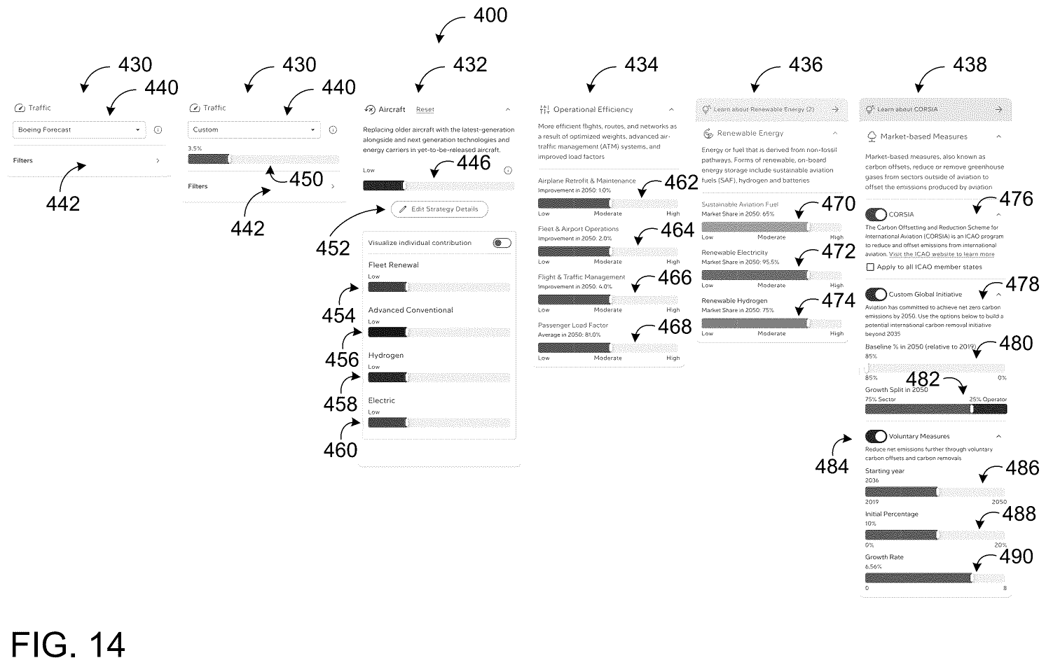

As shown in FIG. 14, conditionally, e.g., based on user input, GUI 400 may include strategic parameters for each modeling strategy 420, as shown in FIG. 13. For example, a user may use forecast dropdown menu 440 to select a custom forecast, revealing traffic growth level 450, allowing the user to set a year-to-year growth percentage along a continuum. In another example GUI 400 may include a plurality of strategic parameters for aircraft type evolution 432. As will be described in further detail with regards to FIGS. 15-17, GUI 400 may include strategy details button 452, along with ambition lever 446, which may enable a user to enter implementation-level parameters. GUI 400 includes a fleet renewal lever 454 that may be set along a continuum from low to high; an advanced conventional lever 456 that may be set along a continuum from low to high, a hydrogen lever 458 that may be set along a continuum from low to high; and an electric lever 460 that may be set along a continuum from low to high. The user may be provided an option to view the individual contributions of these strategic parameters within graph 402, such as is shown in FIG. 15. Other options that are not shown include providing the user with levers for aircraft concepts using hybrid-electric propulsion, other alternative fuels, etc.

Additionally, GUI 400 may include interactive inputs for strategic parameters for aircraft operational efficiency 434. GUI 400 includes an airplane retrofit & maintenance lever 462 that may be set along a continuum from low to high; a fleet and airport operations lever 464 that may set along a continuum from low to high; a flight & traffic management lever 466 that may be set along a continuum from low to high; and a passenger load factor lever 468 that may be set along a continuum from low to high. In this example, moving each lever provides the user feedback as to projected values for the year 2050 based on the lever position.

Additionally, GUI 400 may include interactive inputs for strategic parameters for renewable aircraft energy sources 436. GUI 400 includes a sustainable aviation fuel lever 470 that may be set along a continuum from low to high; a renewable electricity lever 472 that may be set along a continuum from low to high; and a renewable hydrogen lever 474 that may be set along a continuum from low to high. In this example, moving each lever provides the user feedback as to expected market share for the year 2050 based on the lever position.

Additionally, GUI 400 may include interactive inputs for strategic parameters for various kinds of market-based measures 438, which may include carbon offsets, carbon removals, policy measures, etc. GUI 400 includes a CORSIA toggle 476 and a custom global initiative toggle 478 which represent enacted policy and potential future policies, respectively. If the CORSIA toggle 476 is selected, the user may further select whether to apply the CORSIA program to all International Civil Aviation Organization (ICAO) member states. If the custom global initiative toggle 478 is selected, the user may further input strategic parameters corresponding to the design of a future policy to reduce emissions, such as a baseline % in 2050 lever 480, which may be set along a continuum from 85% to 0% (relative to 2019 values); and growth split in 2050 lever 482, which may be set along a continuum from 100% sector growth/0% operator growth and 0% sector growth/100% operator growth. GUI 400 further includes a voluntary measures toggle 484. If voluntary measures toggle 484 is selected, the user may further input strategic parameters via starting year lever 486 that may be set to a year between 2019 and 2050; an initial percentage lever 488 that may be set along a continuum from 0% to 20%; and a growth rate lever 490 that may be set along a continuum from 0% to 8%.

As shown in FIG. 15, GUI 400 may be configured to include parameter inputs 500 alongside modeling strategies 420 and graph 402. Parameter inputs 500 are shown for an active modeling strategy (e.g., aircraft type evolution 432). Parameter inputs 500 are shown including tabs for strategic parameters fleet renewal lever 454, advanced conventional lever 456 (active), hydrogen lever 458, and electric lever 460 (shown in FIG. 14). The active tab (advanced conventional) is accompanied by an overview graphic 501, describing the strategic parameter, and providing additional contextual information relating to the strategy, such as an indication of the reduction in emissions attributable to the strategic parameter given the currently configured implementation level parameters.

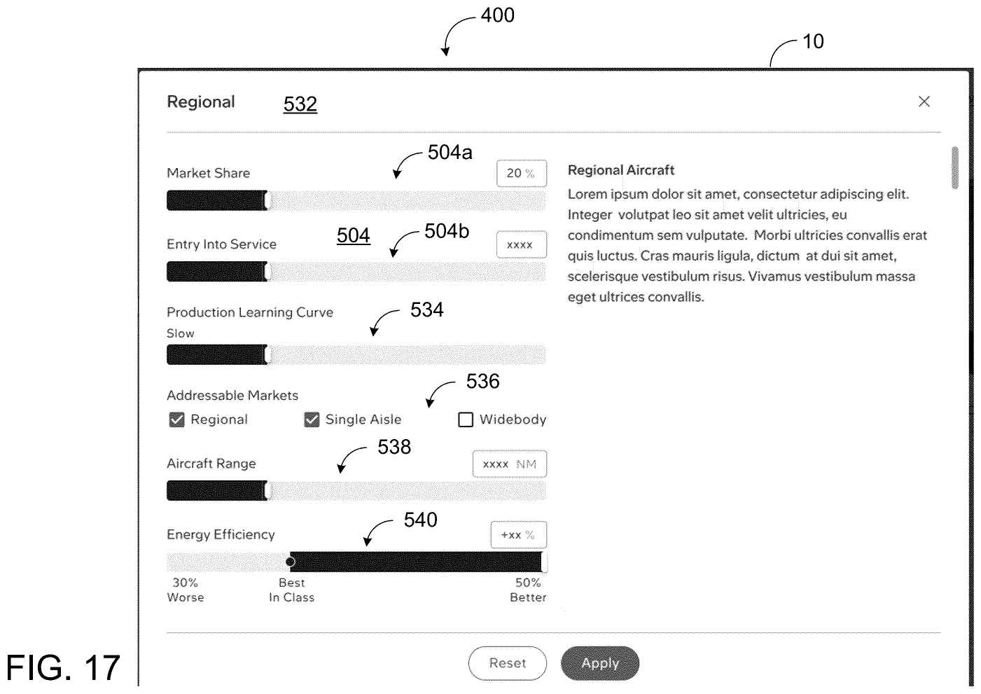

Parameter inputs 500 are shown including a drop-down menu for preset strategies 502. Such preset strategies may include values for a plurality of implementation level parameters. As shown, parameter inputs 500 include an entry bar 504 for regional aircraft that includes entry portals for market share in 2050 and entry into service date (shown as 20% and 2030, respectively). An additional detailed entry button 506 is provided. Detailed entry button 506 may allow the user to input values for additional implementation level parameters that contribute to regional aircraft strategies. Such additional implementation level parameters are described further herein and with regard to FIG. 17. Similarly, parameter inputs 500 include an entry bar 508 for single aisle aircraft that includes entry portals for market share in 2050 and entry into service date (shown as 20% and 2030, respectively). An additional detailed entry button 510 is provided. Additionally, parameter inputs 500 include an entry bar 512 for widebody aircraft that includes entry portals for market share in 2050 and entry into service date (shown as 20% and 2030, respectively). An additional detailed entry button 514 is provided. GUI 400 is also shown to include net aviation emissions 516 at a future date (e.g., 2050) based on the modeled emissions information entered through modeling strategies 420 and parameter inputs 500.

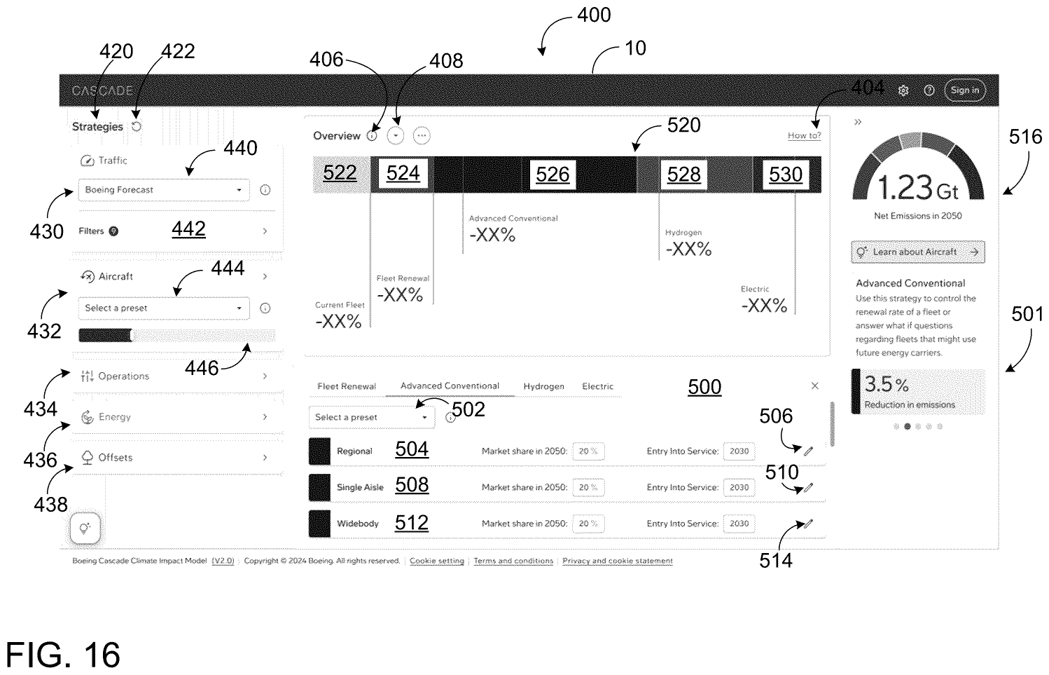

GUI 400 may be configured to show alternate views of aviation emissions data, such as a chart 520 shown in FIG. 16. Chart 520 may be selected via toggle button 408, for example. Chart 520 may be co-visualized along with modeling strategies 420, parameter inputs 500, net aviation emissions 516, etc. In this example, chart 520 corresponds with modeling strategies for aircraft type evolution 432 using input values for evolution strategies dropdown menu 444, strategy details button 452, levers 454, 456, 458, and 460 (as shown in FIG. 14), as well as input values via parameter inputs 500.

As shown in FIG. 16, the chart 520 may display metrics to provide an indication of the composition of a fleet of aircraft in a given year based on the selected modeling parameters. Chart 520 includes a grey colored bar 522 that displays the remaining aircraft from the baseline fleet which are unaffected by the emissions reduction strategies applied. Chart 520 includes a first colored bar 524 corresponding to the new aircraft introduced into the fleet by the fleet renewal strategy parameters. Chart 520 includes a second colored bar 526 corresponding to the aircraft introduced into the fleet by the advanced conventional aircraft strategy parameters. Chart 520 includes a third colored bar 528 corresponding to the aircraft introduced into the fleet by the hydrogen aircraft strategy parameters. Chart 520 includes a fourth colored bar 530 corresponding to the aircraft introduced into the fleet by the electric aircraft strategy parameters. For each colored bar, a numerical representation of the share of the aircraft fleet representing by each respective type of aircraft may also be displayed, as illustrated (e.g. −XX %). In other embodiments, the GUI 400 may be configured to display the metrics in other, easily discernible formats (i.e. pie chart, block diagram, tree map, etc.).

As described, each strategic parameter may include two or more implementation level parameters that can be configured via preset strategies and/or user input. For example, by clicking on detailed entry button 506, a regional aircraft implementation menu 532 may be displayed, as shown in FIG. 17. Regional aircraft implementation menu 532 includes a market share lever 504a and an entry into service lever 504b that corresponds with entry bar 504. Market share lever 504a may be set along a continuum from 0% to 100%. Entry into service lever 504b may be set along a continuum from the current date to 2050.

Regional aircraft implementation menu 532 further includes production learning curve lever 534, which may be set along a continuum from slow to fast implementation speeds. Addressable market tick boxes 536 allow the user to indicate which, if any, of existing regional aircraft, single aisle aircraft, or widebody aircraft in the fleet are eligible to be replaced by the new regional aircraft defined in implementation menu 532. Regional aircraft implementation menu 532 further includes aircraft range lever 538, which may be set along a continuum of range capabilities, and energy efficiency lever 540 which may be set along a continuum to reflect energy efficiency relative to current best in class (e.g., from 30% worse to 50% better).

The implementation level parameters shown in FIG. 17 in part define the modeling strategy for aircraft type evolution 432. Such parameters may be used to construct an API request that generates modeled emissions information and forecasted aviation emissions information based on the aviation emissions information stored in the global database. In some examples, the global database may be filtered (as shown in FIGS. 2A-3B, for example) to reduce the number of flight parameters that the API acts on. For example, implementation level parameters related to regional aircraft may be applied only to regional historic flight parameters. GUI 400 acts as an abstraction layer for constructing such API inputs. In this way, in considering whether to introduce a regional sized advanced conventional aircraft, the user may define constraints, such as how much of the market it takes up, when it enters into service, how fast production scales, and what the addressable markets are. The modeling strategy then applies those parameters to routes flown by regional aircraft today (and/or historically), and how the new aircraft may replace oversized aircraft that currently fly on short regional routes.

FIGS. 18, 19A, and 19B show strategic parameters and implementation level parameters for renewable aircraft energy sources 436. This may allow for users to generate modeled and forecasted emissions information based on process efficiencies, energy requirements, losses and carbon intensities corresponding to various aspects of energy systems, rather than simply range, payload and energy consumption of aircraft. Users can provide input to GUI 400 related to how electricity may be produced in the future, how much of an electrical grid is renewable vs fossil fuels, etc. This allows for analysis of carbon intensities across energy systems that are then applied to aircraft to determine the impact on emissions.

As shown in FIG. 18, GUI 400 may be configured to display strategic parameters for modeling strategies for renewable aircraft energy sources 436. A reset button 550 is displayed allowing the user to return to default strategic parameters. Also presented are preset energy strategies dropdown menu 552 and an energy ambition lever 554. GUI 400 may include strategy details button 556, which may enable a user to enter implementation-level parameters.

As shown in FIG. 18, GUI 400 may be configured to include parameter inputs 558 alongside modeling strategies 420 and graph 402. Parameter inputs 558 are shown for an active modeling strategy (e.g., aircraft energy sources 436). Parameter inputs 558 are shown including tabs for electricity lever 472, hydrogen lever 474, and SAF lever (active) 470. The active tab (SAF) is accompanied by an overview graphic 560, describing the strategic parameter, and providing contextual information pertaining to the strategy, such as an indication of the reduction in emissions attributable to the strategic parameter given the currently configured implementation level parameters.

Parameter inputs 558 are shown including a drop-down menu for preset strategies 562. Such preset strategies may include values for a plurality of implementation level parameters. As shown, parameter inputs 558 include an entry bar 564 for fats, oils, and greases that includes entry portals for market share in 2050 and carbon intensity. An additional detailed entry button 566 is provided. Detailed entry button 566 may allow the user to input values for additional implementation level parameters that contribute to fats, oils, and greases strategies. Similarly, parameter inputs 558 include an entry bar 568 for sugars and starches that includes entry portals for market share in 2050 and carbon intensity. An additional detailed entry button 570 is provided. Additionally, parameter inputs 558 include an entry bar 572 for novel energy crops that includes entry portals for market share in 2050 and carbon intensity. Additional entry bars may be provided for other implementation level parameters such as waste and residues (see FIG. 19A), electrolysis (see FIG. 19B), etc.

As described, each strategic parameter may include two or more implementation level parameters that can be configured via preset strategies and/or user input. For example, by clicking on a detailed entry button (not shown, similar to 566, 570, and 574), a waste and residues menu 576 may be displayed, as shown in FIG. 19A. Waste and residues menu 576 includes a market share lever 578 that may be set along a continuum from 0% to 100%. Waste and resides menu 576 further includes a start year lever 580 that may be set along a continuum from the current date to 2050. Waste and resides menu 576 further includes an insertion shape drop-down menu 582, which allows a user to indicate a speed and trajectory of implementation (e.g., moderately quickly). Waste and resides menu 576 further includes a carbon intensity lever 584 which may be set along a continuum of grams of CO2 per megajoule (MJ). A tick box allows the user to indicate whether the carbon intensity is linked to the grid. Waste and resides menu 576 further includes a conversion efficiency lever 586, which may be set along a continuum of MJ/MJ. Waste and resides menu 576 further includes an output state lever 588 which may be set along a continuum of percentages between 0 and 100.

FIG. 19B shows an electrolysis menu 590 that may be displayed in response to a user clicking on a detailed entry button for electrolysis from the hydrogen tab (not shown). Electrolysis menu 590 includes a market share lever 592 that may be set along a continuum from 0% to 100%. Electrolysis menu 590 further includes a start year lever 594 that may be set along a continuum from the current date to 2050. Electrolysis menu 590 further includes further includes an insertion shape drop-down menu 596, which allows a user to indicate a speed and trajectory of implementation (e.g., moderately quickly). Electrolysis menu 590 further includes a carbon intensity lever 598 which may be set along a continuum of ratios of grams of CO2 per MJ. A tick box allows the user to indicate whether the carbon intensity is linked to the electricity grid, which may be defined by the user in a similar implementation menu for electricity (not shown). Electrolysis menu 590 further includes an electrolysis efficiency lever 600 which may be set along a continuum of percentages between 0 and 100. Electrolysis menu 590 further includes a liquefaction energy lever 602 which may be set along a continuum of ratios of MJ of electricity to MJ of fuel. Electrolysis menu 590 further includes a loss lever 604 which may be set along a continuum of percentages between 0 and 100.

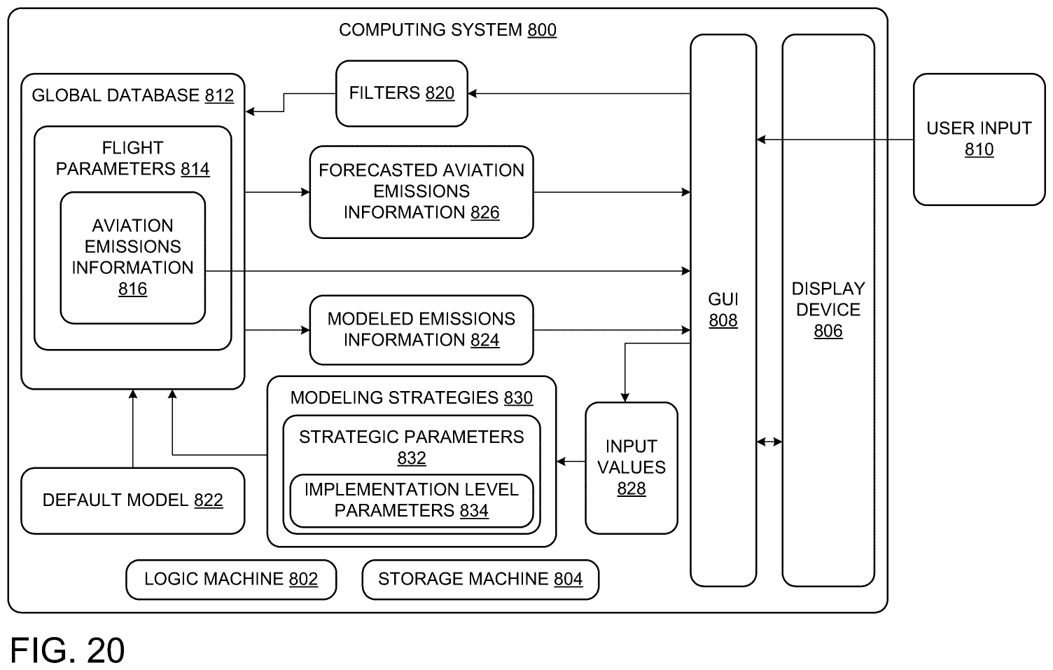

FIG. 20 schematically shows a computing system 800 for graphically displaying aviation emissions information. Computing system 800 includes at least a logic machine 802 (e.g., including one or more processors), a storage machine 804, and a display device 806. Aspects of logic machines, storage machines, and display devices are described further herein and with regard to FIG. 22. Display device 806 may be configured to visually present a graphic user interface 808. GUI 808 may allow for the submission of user input 810, e.g., via mouse clicks, text entry, touch input, natural language input, etc.

Computing system 800 includes a global database 812 of aviation information. Global database 812 may be stored in storage machine 804 and/or be stored remotely and accessed via a communications subsystem. Global database 812 may include flight parameters 814 related to historic flights which may include historical continuous parameter logging (e.g., black box) data, aircraft type, operator, origin-destination pairs, flight time, latitude, longitude, altitude, aircraft weight, flight phase, wind speed, and wind direction. Flight parameters 814 include at least aviation emissions information 816, which may include carbon dioxide emissions, fuel burn, fuel flow-left engine, fuel flow-right engine, etc. Aspects of aviation emissions information 816 may be presented on GUI 808.

Filters 820 may be applied to global database 812 to limit or otherwise reduce the amount of flight parameters used for further analysis. Filters 820 may be applied based on a specific subset of flight parameters 814. Filters 820 may be specified via user input, and/or be based on downstream modeling applications. For example, a modeling analysis may be limited to regional flights or international flights.

A default model 822 may be applied to aviation emissions information 816 to generate modeled emissions information 824 and/or forecasted aviation emissions information 826. Default model 822 may be based on current aviation emissions strategies and may take into account expected future strategies. In this way, current and historic aviation emissions information 816 may be modeled to show future aviation emissions over time.

User input may provide input values 828. Input values 828 may be related to one or more modeling strategies 830, strategic parameters 832, and/or implementation level parameters 834, as described with regard to FIGS. 13-19B. Modeling strategies 830 may then be applied to aviation emissions information 816 to generate modeled emissions information 824 and/or forecasted aviation emissions information 826. Two or more modeling strategies may be applied to aviation emissions information 816, and the resulting modeled emissions information 824 and/or forecasted aviation emissions information 826 may be co-visualized on GUI 808.

Modeling strategies 830 may comprise a modeling library, e.g., a Python library, which allows for scripted analysis of aviation emissions information 816 to generate modeled emissions information 824 and forecasted aviation emissions information 826. In some examples, machine learning approaches, such as linear regression models may be applied to some of the outputs of modeling strategies 830 in order to provide a fast API that approximates the outputs of real physics-space based models.

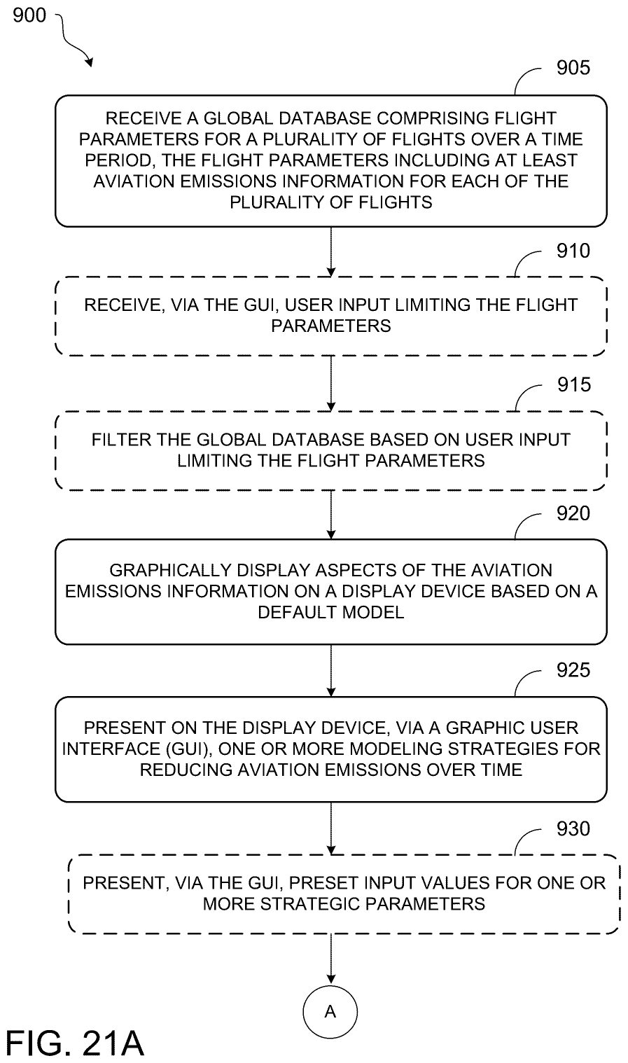

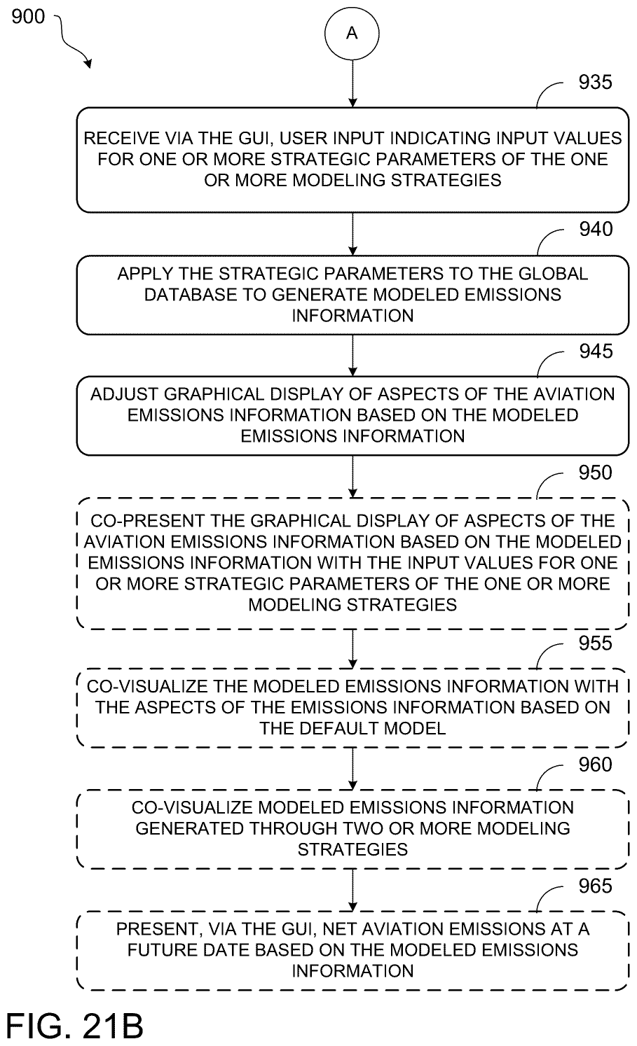

FIGS. 21A and 21B show a flow diagram for an example method 900 for graphically displaying aviation emissions information. Method 900 may be implemented using one or more computing devices, such as computing system 800.

At 905, method 900 includes receiving a global database comprising flight parameters for a plurality of flights over a time period, the flight parameters including at least aviation emissions information for each of the plurality of flights. Optionally, at 910, method 900 includes receiving, via the GUI, user input limiting the flight parameters. Optionally, at 915, method 900 includes filtering the global database based on user input limiting the flight parameters. For example, the aviation emissions information may be filtered to only include regional flights, international flights, flights from one class of aircraft, etc.

At 920, method 900 includes graphically displaying aspects of the aviation emissions information on a display device based on a default model. In some examples, graphically displaying aspects of the aviation emissions information on a display device based on a default model comprises graphically displaying forecasted aviation emissions information determined based on projections for flight parameters for a plurality of flights over a future time period. For example, as shown in FIG. 15, total aircraft emissions may be shown on a year-by-year basis including actual emissions for historic years and projected emissions for forthcoming years.

At 925, method 900 includes presenting on the display device, via a graphic user interface (GUI), one or more modeling strategies for reducing aviation emissions over time. In some examples, the modeling strategies include one or more of aircraft type evolution, aircraft energy sources, aircraft operational efficiency, and market-based offsets. Optionally, at 930, method 900 includes presenting, via the GUI, preset input values for one or more strategic parameters.

Turning to FIG. 21B, at 935, method 900 includes receiving, via the GUI, user input indicating input values for one or more strategic parameters of the one or more modeling strategies. In some examples, the strategic parameters include one or more of a projected market share of a strategy aspect over time, a start date for implementing the strategy aspect, and an implementation curve for the strategy aspect. In some examples, one or more strategy aspects include one or more implementation-level parameters adjustable by user input via the GUI.

At 940, method 900 includes applying the strategic parameters to the global database to generate modeled emissions information. Continuing at 945, method 900 includes adjusting the graphical display of aspects of the aviation emissions information based on the modeled emissions information.

Optionally, at 950, method 900 includes co-presenting the graphical display of aspects of the aviation emissions information based on the modeled emissions information with the input values for one or more strategic parameters of the one or more modeling strategies. In this way, user input that adjusts one or more input values may result in changes to the graphical display of aspects of the aviation emissions information in near-real time.

Optionally, at 955, method 900 includes co-visualizing the modeled emissions information with the aspects of the emissions information based on the default model. In this way, a user may view how changes in strategic parameters improve on aviation emissions over time. Optionally, at 960 method 900 includes co-visualizing modeled emissions information generated through two or more modeling strategies. In this way, a user may view how changes in strategic parameters improve on aviation emissions over time. Optionally, at 965, method 900 includes presenting, via the GUI, net aviation emissions at a future date based on the modeled emissions information. In this way, the user may be able to quickly observe how changes in strategic parameters impact an ability to meet global emissions goals (e.g., in 2050).

FIG. 22 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic machine 1010 and a storage machine 1020. Computing system 1000 may optionally include a display subsystem 1030, input subsystem 1040, communication subsystem 1050, and/or other components not shown in FIG. 22. Display device 10 and computing system 800 are examples of computing system 1000.

Logic machine 1010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1020 includes one or more physical devices configured to hold instructions executable by the logic machine to implement the methods and processes described herein. When such methods and processes are implemented, the state of storage machine 1020 may be transformed—e.g., to hold different data.

Storage machine 1020 may include removable and/or built-in devices. Storage machine 1020 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1020 may include volatile, nonvolatile, dynamic, static, read/write, read-only, random-access, sequential-access, location-addressable, file-addressable, and/or content-addressable devices.

It will be appreciated that storage machine 1020 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1010 and storage machine 1020 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1010 executing instructions held by storage machine 1020. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1030 may be used to present a visual representation of data held by storage machine 1020. This visual representation may take the form of a graphical user interface (GUI). As the herein described methods and processes change the data held by the storage machine, and thus transform the state of the storage machine, the state of display subsystem 1030 may likewise be transformed to visually represent changes in the underlying data. Display subsystem 1030 may include one or more display devices utilizing virtually any type of technology. Such display devices may be combined with logic machine 1010 and/or storage machine 1020 in a shared enclosure, or such display devices may be peripheral display devices.

When included, input subsystem 1040 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1050 may be configured to communicatively couple computing system 1000 with one or more other computing devices. Communication subsystem 1050 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

Further, the disclosure comprises configurations according to the following examples.
Example 1. A method for graphically displaying aviation emissions information, comprising receiving a global database comprising flight parameters for a plurality of flights over a time period, the flight parameters including at least aviation emissions information for each of the plurality of flights; graphically displaying aspects of the aviation emissions information on a display device based on a default model; presenting on the display device, via a graphic user interface (GUI), one or more modeling strategies for reducing aviation emissions over time; receiving via the GUI, user input indicating input values for one or more strategic parameters of the one or more modeling strategies; applying the strategic parameters to the global database to generate modeled emissions information; and adjusting graphical display of aspects of the aviation emissions information based on the modeled emissions information.
Example 2. The method of example 1, wherein graphically displaying aspects of the aviation emissions information on the display device based on the default model comprises graphically displaying forecasted aviation emissions information determined based on projections for flight parameters for the plurality of flights over a future time period.
Example 3. The method of examples 1 to 2, further comprising co-presenting the graphical display of aspects of the aviation emissions information based on the modeled emissions information with the input values for one or more strategic parameters of the one or more modeling strategies.
Example 4. The method of examples 1 to 3, further comprising co-visualizing the modeled emissions information with the aspects of the emissions information based on the default model.
Example 5. The method of examples 1 to 4, further comprising co-visualizing modeled emissions information generated through two or more modeling strategies.
Example 6. The method of examples 1 to 5, further comprising presenting, via the GUI, net aviation emissions at a future date based on the modeled emissions information.
Example 7. The method of examples 1 to 6, further comprising receiving, via the GUI, user input limiting the flight parameters; and filtering the global database based on user input limiting the flight parameters.
Example 8. The method of examples 1 to 7, further comprising presenting, via the GUI, preset input values for the one or more strategic parameters.
Example 9. The method of examples 1 to 8, wherein the strategic parameters include one or more of a projected market share of a strategy aspect over time, a start date for implementing the strategy aspect, and an implementation curve for the strategy aspect.
Example 10. The method of examples 1 to 9, wherein one or more strategy aspects include one or more implementation-level parameters adjustable by user input via the GUI
Example 11. The method of examples 1 to 10, wherein the modeling strategies include one or more of aircraft type evolution, aircraft energy sources, aircraft operational efficiency, and market-based offsets.
Example 12. A computing system for graphically displaying aviation emissions information, comprising a display device; a logic machine comprising one or more processors; a storage machine comprising instructions executable by the one or more processors to: receive a global database comprising flight parameters for a plurality of flights over a time period, the flight parameters including at least aviation emissions information for each of the plurality of flights; graphically display aspects of the aviation emissions information on the display device based on a default model; present on the display device, via a graphic user interface (GUI), one or more modeling strategies for reducing aviation emissions over time; receive via the GUI, user input indicating input values for one or more strategic parameters of the one or more modeling strategies; apply the strategic parameters to the global database to generate modeled emissions information; and adjusting graphical display of aspects of the aviation emissions information based on the modeled emissions information.
Example 13. The computing system of example 12, wherein graphically displaying aspects of the aviation emissions information on the display device based on the default model comprises graphically displaying forecasted aviation emissions information determined based on projections for flight parameters for a plurality of flights over a future time period.
Example 14. The computing system of examples 12 to 13, wherein the storage device further comprises instructions executable by the one or more processors to co-present the graphical display of aspects of the aviation emissions information based on the modeled emissions information with the input values for one or more strategic parameters of the one or more modeling strategies.
Example 15. The computing system of examples 12 to 14, further comprising co-visualizing the modeled emissions information with the aspects of the emissions information based on the default model.
Example 16. The computing system of examples 12 top 15, wherein the strategic parameters include one or more of a projected market share of a strategy aspect over time, a start date for implementing the strategy aspect, and an implementation curve for the strategy aspect
Example 17. The computing system of examples 12 to 16, wherein the modeling strategies include one or more of aircraft type evolution, aircraft energy sources, aircraft operational efficiency, and market-based offsets.
Example 18. A method for graphically displaying aviation emissions information, comprising receiving a global database comprising flight parameters for a plurality of flights over a time period, the flight parameters including at least aviation emissions information for each of the plurality of flights; graphically displaying aspects of the aviation emissions information on a display device based on a default model; presenting on the display device, via a graphic user interface (GUI), one or more modeling strategies for reducing aviation emissions over time; receiving via the GUI, user input indicating input values for one or more strategic parameters of the one or more modeling strategies, the strategic parameters including one or more of a projected market share of a strategy aspect over time, a start date for implementing the strategy aspect, and an implementation curve for the strategy aspect; applying the strategic parameters to the global database to generate modeled emissions information; adjusting the graphical display of aspects of the aviation emissions information based on the modeled emissions information; and co-presenting the graphical display of aspects of the aviation emissions information based on the modeled emissions information with the input values for one or more strategic parameters of the one or more modeling strategies.
Example 19. The method of example 18, wherein the modeling strategy includes aircraft type evolution.
Example 20. The method of examples 18 to 19, wherein the modeling strategy includes aircraft energy sources.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for graphically displaying aviation emissions information, comprising:
receiving a global database comprising flight parameters for a plurality of flights over a time period, the flight parameters including at least aviation emissions information for each of the plurality of flights;
graphically displaying aspects of the aviation emissions information on a display device based on a default model;
presenting on the display device, via a graphic user interface (GUI), one or more modeling strategies for reducing aviation emissions over time;
receiving via the GUI, user input indicating input values for one or more strategic parameters of the one or more modeling strategies;
applying the strategic parameters to the global database to generate modeled emissions information; and
adjusting graphical display of aspects of the aviation emissions information based on the modeled emissions information.

2. The method of claim 1, wherein graphically displaying aspects of the aviation emissions information on the display device based on the default model comprises graphically displaying forecasted aviation emissions information determined based on projections for flight parameters for the plurality of flights over a future time period.

3. The method of claim 1, further comprising:
co-presenting the graphical display of aspects of the aviation emissions information based on the modeled emissions information with the input values for one or more strategic parameters of the one or more modeling strategies.

4. The method of claim 1, further comprising:
co-visualizing the modeled emissions information with the aspects of the emissions information based on the default model.

5. The method of claim 4, further comprising:
co-visualizing modeled emissions information generated through two or more modeling strategies.

6. The method of claim 4, further comprising:
presenting, via the GUI, net aviation emissions at a future date based on the modeled emissions information.

7. The method of claim 1, further comprising:
receiving, via the GUI, user input limiting the flight parameters; and
filtering the global database based on user input limiting the flight parameters.

8. The method of claim 1, further comprising:
presenting, via the GUI, preset input values for the one or more strategic parameters.

9. The method of claim 1, wherein the strategic parameters include one or more of a projected market share of a strategy aspect over time, a start date for implementing the strategy aspect, and an implementation curve for the strategy aspect.

10. The method of claim 1, wherein one or more strategy aspects include one or more implementation-level parameters adjustable by user input via the GUI.

11. The method of claim 1, wherein the modeling strategies include one or more of aircraft type evolution, aircraft energy sources, aircraft operational efficiency, and market-based offsets.

12. A computing system for graphically displaying aviation emissions information, comprising:
a display device;
a logic machine comprising one or more processors;
a storage machine comprising instructions executable by the one or more processors to:
receive a global database comprising flight parameters for a plurality of flights over a time period, the flight parameters including at least aviation emissions information for each of the plurality of flights;
graphically display aspects of the aviation emissions information on the display device based on a default model;
present on the display device, via a graphic user interface (GUI), one or more modeling strategies for reducing aviation emissions over time;
receive via the GUI, user input indicating input values for one or more strategic parameters of the one or more modeling strategies;
apply the strategic parameters to the global database to generate modeled emissions information; and
adjusting graphical display of aspects of the aviation emissions information based on the modeled emissions information.

13. The computing system of claim 12, wherein graphically displaying aspects of the aviation emissions information on the display device based on the default model comprises graphically displaying forecasted aviation emissions information determined based on projections for flight parameters for a plurality of flights over a future time period.

14. The computing system of claim 12, wherein the storage device further comprises instructions executable by the one or more processors to:
co-present the graphical display of aspects of the aviation emissions information based on the modeled emissions information with the input values for one or more strategic parameters of the one or more modeling strategies.

15. The computing system of claim 12, further comprising:
co-visualizing the modeled emissions information with the aspects of the emissions information based on the default model.

16. The computing system of claim 12, wherein the strategic parameters include one or more of a projected market share of a strategy aspect over time, a start date for implementing the strategy aspect, and an implementation curve for the strategy aspect.

17. The computing system of claim 12, wherein the modeling strategies include one or more of aircraft type evolution, aircraft energy sources, aircraft operational efficiency, and market-based offsets.

18. A method for graphically displaying aviation emissions information, comprising:
receiving a global database comprising flight parameters for a plurality of flights over a time period, the flight parameters including at least aviation emissions information for each of the plurality of flights;
graphically displaying aspects of the aviation emissions information on a display device based on a default model;
presenting on the display device, via a graphic user interface (GUI), one or more modeling strategies for reducing aviation emissions over time;
receiving via the GUI, user input indicating input values for one or more strategic parameters of the one or more modeling strategies, the strategic parameters including one or more of a projected market share of a strategy aspect over time, a start date for implementing the strategy aspect, and an implementation curve for the strategy aspect;
applying the strategic parameters to the global database to generate modeled emissions information;
adjusting the graphical display of aspects of the aviation emissions information based on the modeled emissions information; and
co-presenting the graphical display of aspects of the aviation emissions information based on the modeled emissions information with the input values for one or more strategic parameters of the one or more modeling strategies.

19. The method of claim 18, wherein the modeling strategy includes aircraft type evolution.

20. The method of claim 18, wherein the modeling strategy includes aircraft energy sources.
